(19) United States
(12) Patent Application Publication
(10) Pub. No.: US 2017/0244981 A1
(43) Pub. Date: Aug. 24, 2017

(54) RECONFIGURABLE INTERPOLATION FILTER AND ASSOCIATED INTERPOLATION FILTERING METHOD

(71) Applicant: MEDIATEK INC., Hsin-Chu (TW)

(72) Inventors: Chi-Hung Chen, Hsinchu City (TW); Yung-Chang Chang, New Taipei City (TW); Chih-Ming Wang, Hsinchu County (TW)

(21) Appl. No.: 15/439,947

(22) Filed: Feb. 23, 2017

Related U.S. Application Data
(60) Provisional application No. 62/299,065, filed on Feb. 24, 2016.

(51) Int. Cl. H04N 19/82; H04N 19/176; H04N 19/59; H04N 19/182

(52) U.S. Cl. CPC H04N 19/82; H04N 19/182; H04N 19/176; H04N 19/59

(57) ABSTRACT

A reconfigurable interpolation filter has an L×1 parallelism integer pixel and sub-integer pixel processing filter and a filter configuration circuit. The L×1 parallelism integer pixel and sub-integer pixel processing filter calculates L filtered samples at a same pixel line in a parallel fashion, wherein L is a positive integer not smaller than one. The filter configuration circuit reconfigures the L×1 parallelism integer pixel and sub-integer pixel processing filter into an (L/M)×M parallelism integer pixel and sub-integer pixel processing filter according to a width of a prediction block. The (L/M)×M parallelism integer pixel and sub-integer pixel processing filter processes the prediction block by calculating L/M filtered samples at each of M pixel lines in a parallel fashion, wherein M is a positive integer not smaller than one, and L/M is a positive integer.

### CROSS REFERENCE TO RELATED APPLICATIONS

This applicant claims the benefit of U.S. provisional application No. 62/299,065, filed on Feb. 24, 2016 and incorporated herein by reference.

### BACKGROUND

The present invention relates to a filter design, and more particularly, to a reconfigurable interpolation filter and an associated interpolation filtering method.

The conventional video coding standards generally adopt a block based coding technique to exploit spatial and temporal redundancy. For example, the basic approach is to divide the whole source frame into a plurality of blocks, perform intra prediction/inter prediction on each block, transform residues of each block, and perform quantization and entropy encoding. Besides, a reconstructed frame is generated in a coding loop to provide reference pixel data used for coding following blocks. For certain video coding standards, in-loop filter(s) may be used for enhancing the image quality of the reconstructed frame.

A video decoder is used to perform an inverse operation of a video encoding operation performed by a video encoder. For example, motion estimation is performed by the video encoder for inter prediction of a block, and motion compensation is performed by the video decoder for reconstruction of a block. When the video encoder employs an integer-pixel and sub-integer pixel motion estimation algorithm, motion vectors found for blocks of a frame may include motion vectors with integer-pixel accuracy and motion vectors with sub-integer pixel accuracy. In general, an interpolation filter is needed for motion compensation at the video decoder for processing integer pixels of reference frames to obtain prediction blocks with sub-integer pixel accuracy for some blocks as well as prediction blocks with integer-pixel accuracy for other blocks. Hence, the design of the interpolation filter is critical to the motion compensation performance at the video decoder.

### SUMMARY

One of the objectives of the claimed invention is to provide a reconfigurable interpolation filter and an associated interpolation filtering method.

According to a first aspect of the present invention, an exemplary reconfigurable interpolation filter is disclosed. The exemplary reconfigurable interpolation filter includes an L×1 parallelism integer pixel and sub-integer pixel processing filter and a filter configuration circuit. The L×1 parallelism integer pixel and sub-integer pixel processing filter is arranged to calculate L filtered samples at a same pixel line in a parallel fashion, wherein L is a positive integer not smaller than one. The filter configuration circuit is arranged to reconfigure the L×1 parallelism integer pixel and sub-integer pixel processing filter into an (L/M)×M parallelism integer pixel and sub-integer pixel processing filter according to a width of a prediction block, wherein the (L/M)×M parallelism integer pixel and sub-integer pixel processing filter is arranged to process the prediction block by calculating L/M filtered samples at each of M pixel lines in a parallel fashion, M is a positive integer not smaller than one, and L/M is a positive integer.

According to a second aspect of the present invention, an exemplary reconfigurable interpolation filter is disclosed. The exemplary reconfigurable interpolation filter includes an L×1 parallelism integer pixel and sub-integer pixel processing filter and a filter configuration circuit. The L×1 parallelism integer pixel and sub-integer pixel processing filter is arranged to calculate L filtered samples at a same pixel line in a parallel fashion, wherein L is a positive integer not smaller than one. The filter configuration circuit is arranged to reconfigure the L×1 parallelism integer pixel and sub-integer pixel processing filter into a plurality of parallelism integer pixel and sub-integer pixel processing filters according to widths of a plurality of prediction blocks, respectively, wherein the parallelism integer pixel and sub-integer pixel processing filters are arranged to process the prediction blocks by calculating filtered samples associated with the prediction blocks in a parallel fashion, and each of the parallelism integer pixel and sub-integer pixel processing filters is arranged to calculate filtered samples at a same pixel line.

According to a third aspect of the present invention, an exemplary interpolation filtering method is disclosed. The exemplary interpolation filtering method includes: utilizing an L×1 parallelism integer pixel and sub-integer pixel processing filter for calculating L filtered samples at a same pixel line in a parallel fashion, wherein L is a positive integer not smaller than one; reconfiguring the L×1 parallelism integer pixel and sub-integer pixel processing filter into an (L/M)×M parallelism integer pixel and sub-integer pixel processing filter according to a width of a prediction block; and utilizing the (L/M)×M parallelism integer pixel and sub-integer pixel processing filter to process the prediction block by calculating L/M filtered samples at each of M pixel lines in a parallel fashion, wherein M is a positive integer not smaller than one, and L/M is a positive integer.

According to a fourth aspect of the present invention, an exemplary interpolation filtering method is disclosed. The exemplary interpolation filtering method includes: utilizing an L×1 parallelism integer pixel and sub-integer pixel processing filter for calculating L filtered samples at a same pixel line in a parallel fashion, wherein L is a positive integer not smaller than one; reconfiguring the L×1 parallelism integer pixel and sub-integer pixel processing filter into a plurality of parallelism integer pixel and sub-integer pixel processing filters according to widths of a plurality of prediction blocks, respectively; and utilizing the parallelism integer pixel and sub-integer pixel processing filters to process the prediction blocks by calculating filtered samples associated with the prediction blocks in a parallel fashion, wherein each of the parallelism integer pixel and sub-integer pixel processing filters calculates filtered samples at a same pixel line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video decoder using a reconfigurable motion compensation interpolation filter according to an embodiment of the present invention.

FIG. 2 is a diagram illustrating different partition types of a coding block.

FIG. 3 is a diagram illustrating a reconfigurable interpolation filter according to an embodiment of the present invention.

FIG. 4 is a diagram illustrating folded integer pixel and sub-integer pixel processing filter architecture used under a first processing order (e.g., horizontal filtering→vertical filtering) according to an embodiment of the present invention.

FIG. 5 is a diagram illustrating horizontal filtering of N×2N prediction block interpolation with a folded integer pixel and sub-integer pixel processing filter according to an embodiment of the present invention.

FIG. 6 is a diagram illustrating the horizontally filtered samples calculated by the horizontal filtering of the 4×8 prediction block interpolation.

FIG. 7 is a diagram illustrating vertical filtering of N×2N prediction block interpolation with a folded integer pixel and sub-integer pixel processing filter according to an embodiment of the present invention.

FIG. 8 is a diagram illustrating first horizontal filtering of 2N×2N prediction block interpolation with a folded integer pixel and sub-integer pixel processing filter according to an embodiment of the present invention.

FIG. 9 is a diagram illustrating first vertical filtering of 2N×2N prediction block interpolation with a folded integer pixel and sub-integer pixel processing filter according to an embodiment of the present invention.

FIG. 10 is a diagram illustrating second horizontal filtering of 2N×2N prediction block interpolation with a folded integer pixel and sub-integer pixel processing filter according to an embodiment of the present invention.

FIG. 11 is a diagram illustrating second vertical filtering of 2N×2N prediction block interpolation with a folded integer pixel and sub-integer pixel processing filter according to an embodiment of the present invention.

FIG. 12 is a diagram illustrating folded integer pixel and sub-integer pixel processing filter architecture used under a second processing order (e.g., vertical filtering→horizontal filtering) according to an embodiment of the present invention.

FIG. 13 is a diagram illustrating composed integer pixel and sub-integer pixel processing filter architecture used under a first processing order (e.g., horizontal filtering→vertical filtering) according to an embodiment of the present invention.

FIG. 14 is a diagram illustrating horizontal filtering of two N×2N prediction block interpolations with two composed integer pixel and sub-integer pixel processing filters according to an embodiment of the present invention.

FIG. 15 is a diagram illustrating vertical filtering of two parallel N×2N prediction block interpolations with two composed integer pixel and sub-integer pixel processing filters according to an embodiment of the present invention.

FIG. 16 is a diagram illustrating horizontal filtering of two nL×2N prediction block interpolations with two composed integer pixel and sub-integer pixel processing filters according to an embodiment of the present invention.

FIG. 17 is a diagram illustrating vertical filtering of 2×8 prediction block interpolation and 6×8 prediction block interpolation with two composed integer pixel and sub-integer pixel processing filters according to an embodiment of the present invention.

FIG. 18 is a diagram illustrating composed integer pixel and sub-integer pixel processing filter architecture used under a second processing order (e.g., vertical filtering→horizontal filtering) according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

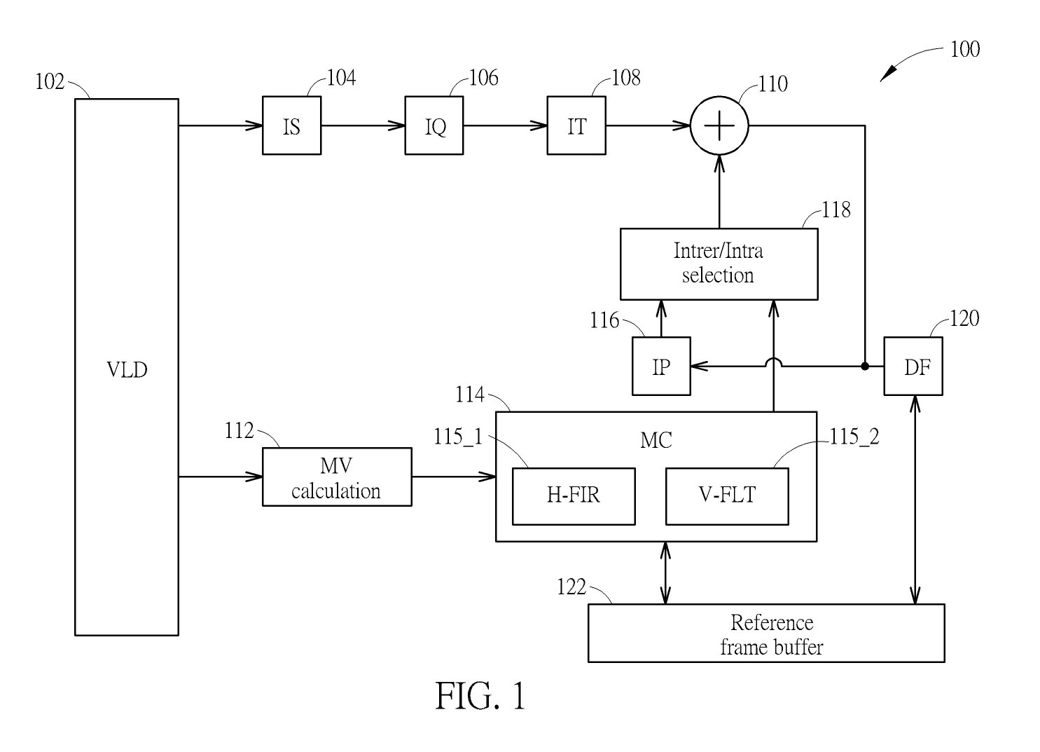

FIG. 1 is a diagram illustrating a video decoder using a reconfigurable motion compensation interpolation filter according to an embodiment of the present invention. As shown in FIG. 1, the video decoder 100 includes an entropy decoder (e.g., a variable length decoder (VLD) 102), an inverse scan circuit (denoted by “IS”) 104, an inverse quantization circuit (denoted by “IQ”) 106, an inverse transform circuit (denoted by “IT”) 108, a reconstruction circuit 110, a motion vector calculation circuit (denoted by “MV calculation”) 112, a motion compensation circuit (denoted by “MC”) 114, an intra prediction circuit (denoted by “IP”) 116, an inter/intra mode selection circuit (denoted by “Inter/intra selection”) 118, an in-loop filter (e.g., a deblocking filter (DF) 120), and a reference frame buffer 122. When a block is inter-coded, the motion vector calculation circuit 112 refers to information parsed from an encoded bitstream by the VLD 102 to determine a motion vector between the block of a current frame being decoded and a prediction block of a reference frame that is a reconstructed frame and stored in the reference frame buffer 122. The motion compensation circuit 114 includes a horizontal filter (denoted by “H-FIR”) 115_1 arranged to perform interpolation filtering in a pixel row direction, and a vertical filter (denoted by “V-FLT”) 115_2 arranged to perform interpolation filtering in a pixel column direction. In this embodiment, the motion compensation circuit 114 employs the proposed reconfigurable motion compensation interpolation filter architecture to reconfigure each of the horizontal filter 115_1 and the vertical filter 115_2, and is used to determine/calculate the prediction block used for reconstruction of the block.

The prediction block may have integer-pixel accuracy or sub-integer pixel accuracy, depending upon the motion vector determined by the motion vector calculation circuit 112. The prediction is supplied to the inter/intra mode selection circuit 118. Since the block is inter-coded, the inter/intra mode selection circuit 118 outputs the prediction block to the reconstruction circuit 110. In addition, decoded residual of the block is obtained by the reconstruction circuit 110 through the variable length decoder 102, the inverse scan circuit 104, the inverse quantization circuit 106, and the inverse transform circuit 108. The reconstruction circuit 110 combines the decoded residual and the prediction block to generate a reconstructed block for the inter-coded block. The reconstructed block is processed by the deblocking filter 120 and then stored into the reference frame buffer to be a part of a reference frame that may be used for decoding following frames.

It should be noted that the video decoder structure shown in FIG. 1 is for illustrative purposes only, and is not meant to be a limitation of the present invention. In practice, the reconfigurable motion compensation interpolation filter (e.g., horizontal filter 115_1 and/or vertical filter 115_2) may be employed by any video decoder design that uses motion compensation to determine a prediction block for reconstruction of an inter-coded block. In this embodiment, the reconfigurable motion compensation interpolation filter (e.g., horizontal filter 115_1 and/or vertical filter 115_2) employs parallelism filter architecture for enhancing the interpolation filter performance. In addition, to achieve full utilization, the reconfigurable motion compensation interpolation filter (e.g., horizontal filter 115_1 and/or vertical filter 115_2) is capable of adaptively changing its filter arrangement according to interpolation filtering requirements for different prediction block sizes.

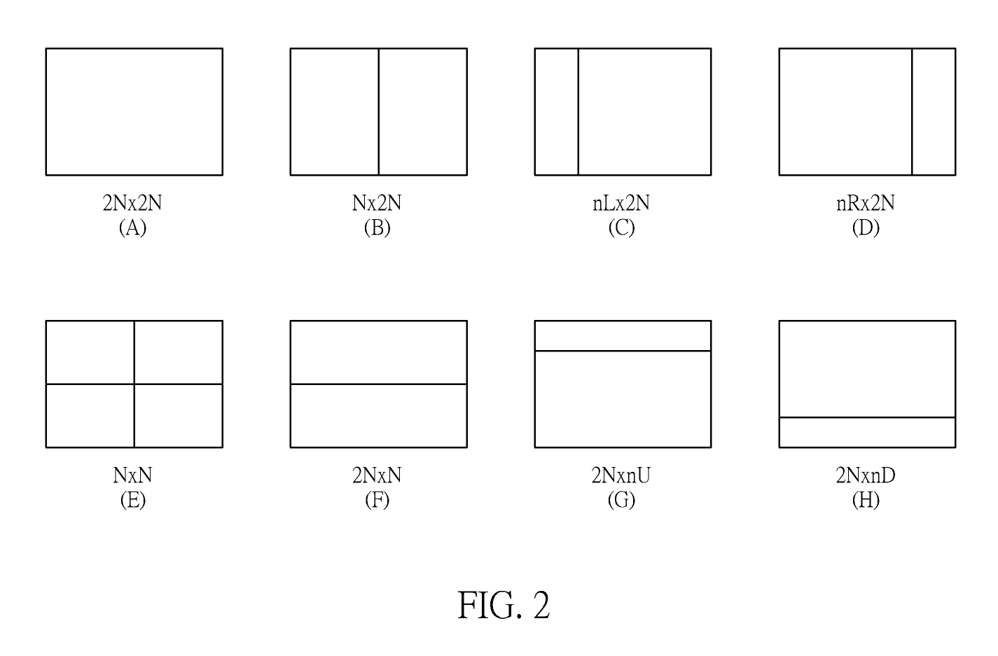

Due to the increase of the video resolution, a larger coding block may be used to improve the compression efficiency. For example, a coding block size may vary from 64×64 to 8×8. To achieve better visual quality of the decoded frame, smaller-sized prediction blocks may be used for inter prediction. That is, sub-division may be applied to a large-sized coding block to partition the large-sized coding block into small-sized prediction blocks. FIG. 2 is a diagram illustrating different partition types of a coding block. When the partition type 2N×2N as illustrated in sub-diagram (A) of FIG. 2 is used, the prediction block and the coding block have the same size. When the partition type N×2N as illustrated in sub-diagram (B) of FIG. 2 is used, the coding block is partitioned into two prediction blocks, horizontally and equally. When the partition type nL×2N as illustrated in sub-diagram (C) of FIG. 2 or the partition type nR×2N as illustrated in sub-diagram (D) of FIG. 2 is used, the coding block is partitioned into two prediction blocks, horizontally and unequally. When the partition type N×N as illustrated in sub-diagram (E) of FIG. 2 is used, the coding block is partitioned into four same-sized prediction blocks. When the partition type 2N×N as illustrated in sub-diagram (F) of FIG. 2 is used, the coding block is partitioned into two prediction blocks, vertically and equally. When the partition type 2N×nU as illustrated in sub-diagram (G) of FIG. 2 or the partition type 2N×nD as illustrated in sub-diagram (H) of FIG. 2 is used, the coding block is partitioned into two prediction blocks, vertically and unequally.

The variable size of the prediction block is bad to the typical regular hardware implementation. For example, an 8×1 parallelism integer pixel and sub-integer pixel processing filter may include 8 filters used for calculating 8 filtered samples (e.g., integer pixels or sub-integer pixels) in parallel. Concerning a 2N×2N prediction block (e.g., 8×8 prediction block with N=4), the 8×1 parallelism integer pixel and sub-integer pixel processing filter is fully utilized due to the fact that the width of the 8×8 prediction block is equal to the number of filters. Hence, all of the 8 filters in the 8×1 parallelism integer pixel and sub-integer pixel processing filter are active for calculating 8 filtered samples at the same pixel row or the same pixel column. However, when the width of the prediction block is smaller than the number of filters, the 8×1 parallelism integer pixel and sub-integer pixel processing filter is partially utilized. For example, concerning an N×2N prediction block (e.g., 4×8 prediction block with N=4), only 4 filters in the 8×1 parallelism integer pixel and sub-integer pixel processing filter are active for calculating 4 filtered samples at the same pixel row or the same pixel column, while the remaining 4 filters in the 8×1 parallelism integer pixel and sub-integer pixel processing filter are idle. As a result, the filter utilization of the 8×1 parallelism integer pixel and sub-integer pixel processing filter is worse when the width of the prediction block becomes smaller. To solve this low filter utilization issue, the present invention proposes using a reconfigurable interpolation filter (e.g., horizontal filter 115_1 and/or vertical filter 115_2 used by motion compensation circuit 114 of video decoder 100). Further details of the proposed reconfigurable interpolation filter are described as below.

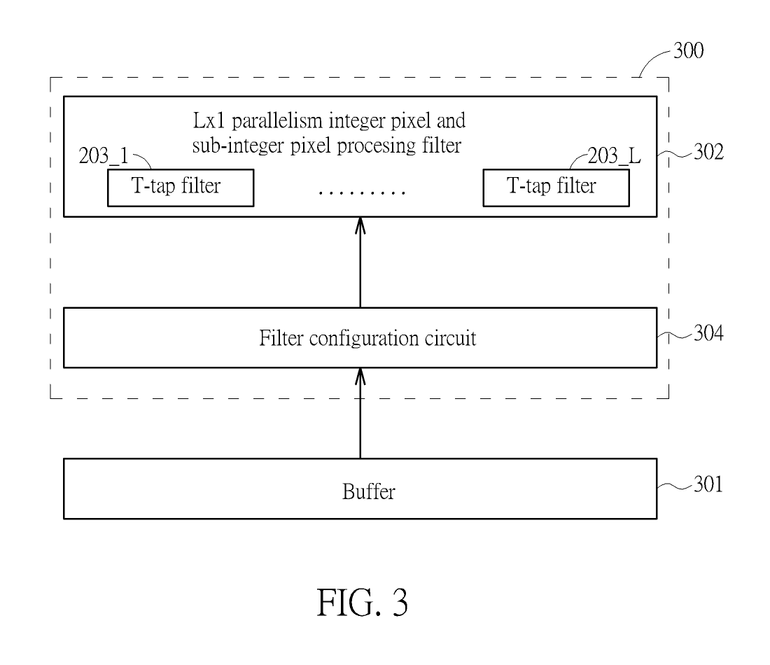

FIG. 3 is a diagram illustrating a reconfigurable interpolation filter according to an embodiment of the present invention. By way of example, but not limitation, the horizontal filter 115_1 shown in FIG. 1 may be implemented using a filter structure same as that of the reconfigurable interpolation filter 300 shown in FIG. 3, and/or the vertical filter 115_2 shown in FIG. 1 may be implemented using a filter structure same as that of the reconfigurable interpolation filter 300 shown in FIG. 3. In this embodiment, the reconfigurable interpolation filter 300 includes an L×1 parallelism integer pixel and sub-integer pixel processing filter 302 and a filter configuration circuit 304. In one exemplary embodiment, the reconfigurable interpolation filter 300 may have a Y×1 parallelism integer pixel and sub-integer pixel processing filter, and the L×1 parallelism integer pixel and sub-integer pixel processing filter 302 is at least a portion (e.g., part or all) of the Y×1 parallelism integer pixel and sub-integer pixel processing filter that can be reconfigured by the filter configuration circuit 304 to be fully utilized for interpolation filtering of prediction block(s), where Y≧L.

The L×1 parallelism integer pixel and sub-integer pixel processing filter 302 includes a plurality of T-tap filters 203_1-203_L, where L is a positive integer not smaller than one (i.e., L≧1), and T is a positive integer not smaller than one (i.e., T≧1). The L×1 parallelism integer pixel and sub-integer pixel processing filter 302 is arranged to calculate L filtered samples at the same pixel line (e.g., the same pixel row for horizontal filtering or the same pixel row for vertical filtering) in a parallel fashion. Hence, due to parallel processing, L filtered samples may be calculated and output during the same clock cycle. For example, the L×1 parallelism integer pixel and sub-integer pixel processing filter 302 may be an 8-parallelism integer pixel and sub-integer pixel processing filter (L=8), such that the 8-parallelism integer pixel and sub-integer pixel processing filter may be fully utilized for calculating filtered samples associated with a 2N×2N prediction block (e.g., 8×8 prediction block with N=4).

The T-tap filters 203_1-203_L may be designed according to the coding standard used. For example, the T-tap filters 203_1-203_L may be 8-tap FIR (Finite Impulse Response) filters for MPEG4 bi-cubic interpolation, HEVC (High Efficiency Video Coding) interpolation or VP9 interpolation (T=8), may be 6-tap FIR filters for H.264 interpolation, RV9/RV10 interpolation or VP8 interpolation (T=6), may be 4-tap FIR filters for RV8 interpolation, WMV (Windows Media Video) bi-cubic interpolation, AVS (Audio Video coding Standard) interpolation or VP6 bi-cubic interpolation (L=4), or may be bi-linear filters for MPEG2 interpolation, MPEG4 bi-linear interpolation, WMV bi-linear interpolation or VP6 bi-linear interpolation (T=2).

As mentioned above, the L×1 parallelism integer pixel and sub-integer pixel processing filter 302 may be fully utilized for calculating filtered samples associated with a 2N×2N prediction block, where 2N=L. However, the prediction block is allowed to have a variable size for certain video coding applications. As a result, the L×1 parallelism integer pixel and sub-integer pixel processing filter 302 may not be fully utilized for calculating filtered samples associated with a prediction block with a size different from 2N×2N. In this embodiment, the filter configuration circuit 304 is arranged to reconfigure the L×1 parallelism integer pixel and sub-integer pixel processing filter 302 according to interpolation requirement of prediction block(s). For example, the filter configuration circuit 304 may control data paths between a buffer 301 (e.g., reference frame buffer 122 or a working buffer) and T-tap filters 203_1-203_L to achieve reconfiguration of the L×1 parallelism integer pixel and sub-integer pixel processing filter 302. In other words, by controlling the input samples (i.e., raw pixels) read from the reference frame buffer 122 and fed into the T-tap filters 203_1-203_L (or by controlling the filtered samples (e.g., horizontally filtered samples or vertically filtered samples) read from the working buffer and fed into the T-tap filters 203_1-203_L), the L×1 parallelism integer pixel and sub-integer pixel processing filter 302 may be reconfigured to have folded integer pixel and sub-integer pixel processing filter architecture for parallel calculation of filtered samples associated with the same prediction block, or may be reconfigured to have composed integer pixel and sub-integer pixel processing filter architecture for parallel calculation of filtered samples associated with different prediction blocks.

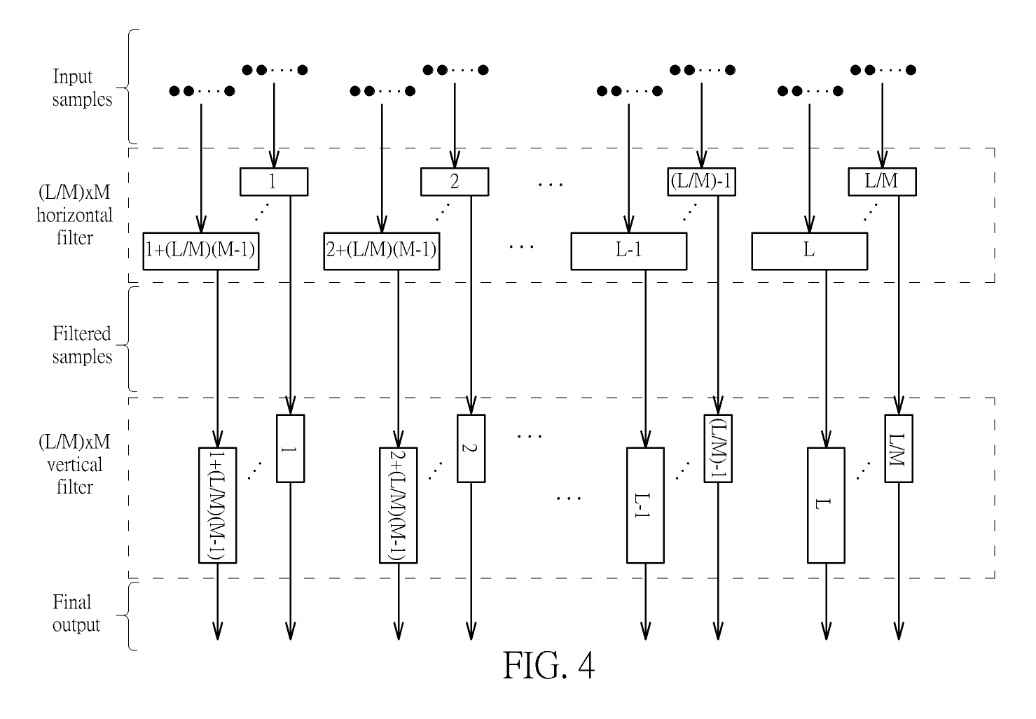

FIG. 4 is a diagram illustrating folded integer pixel and sub-integer pixel processing filter architecture used under a first processing order (e.g., horizontal filtering→vertical filtering) according to an embodiment of the present invention. The filter configuration circuit 304 reconfigures the L×1 parallelism integer pixel and sub-integer pixel processing filter 302 into an (L/M)×M parallelism integer pixel and sub-integer pixel processing filter according to a width of a prediction block. The (L/M)×M parallelism integer pixel and sub-integer pixel processing filter is arranged to process the prediction block by calculating L/M filtered samples at each of M pixel lines (e.g., M pixel rows for horizontal filtering or M pixel rows for vertical filtering) in a parallel fashion, where M is a positive integer not smaller than one (i.e., M≧1), and L/M is a positive integer. For example, M may be 2, 4 or 8, depending upon the width of the prediction block.

In this embodiment, each of horizontal filter 115_1 and vertical filter 115_2 shown in FIG. 1 may be implemented using the reconfigurable interpolation filter 300 shown in FIG. 3. As shown in FIG. 4, the horizontal filter 115_1 may have one L×1 parallelism integer pixel and sub-integer pixel processing filter 302 reconfigured to serve as an (L/M)×M horizontal filter for performing interpolation filtering upon input samples (e.g., raw integer pixels) in a pixel row direction, and the vertical filter 115_2 may have one L×1 parallelism integer pixel and sub-integer pixel processing filter 302 reconfigured to serve as an (L/M)×M vertical filter for performing interpolation filtering upon horizontally filtered samples in a pixel column direction to generate a final output (e.g., horizontally and vertically filtered samples of the prediction block).

The (L/M)×M parallelism integer pixel and sub-integer pixel processing filter includes the T-tap filters 203_1-203_L folded to form multiple (L/M)×1 parallelism integer pixel and sub-integer pixel processing filters. As shown in FIG. 4, the first (L/M)×1 parallelism integer pixel and sub-integer pixel processing filter is composed of T-tap filters 203_i, where i=1, 2, . . . (L/M)−1, L/M; and the last (L/M)×1 parallelism integer pixel and sub-integer pixel processing filter is composed of T-tap filters 203_i, where i=1+(L/M) (M−1), 2+(L/M) (M−1), . . . L−1, L.

For better understanding of technical features of the folded integer pixel and sub-integer pixel processing filter architecture shown in FIG. 4, several examples are discussed as below.

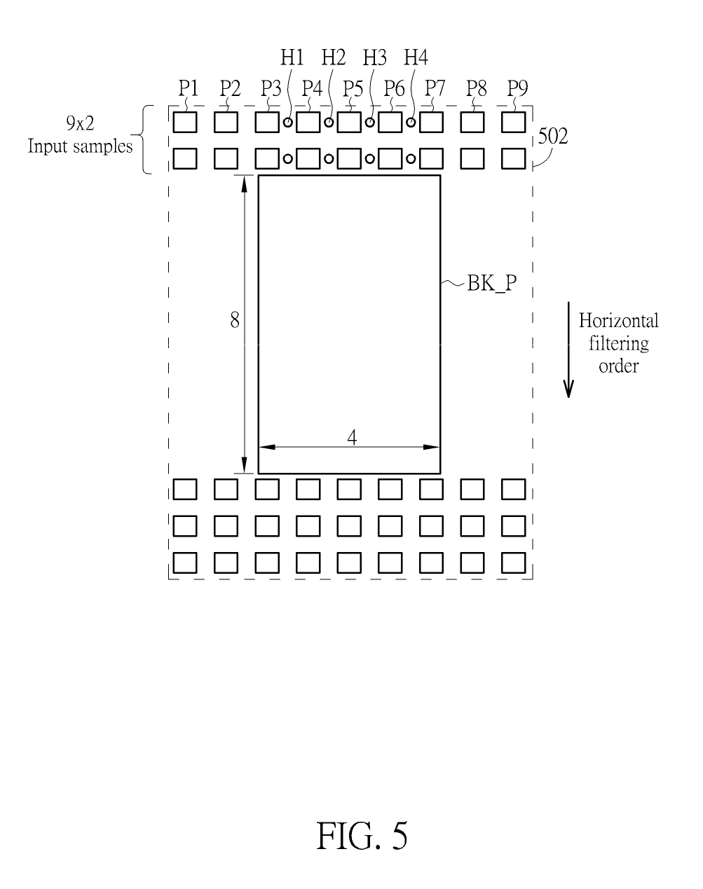

FIG. 5 is a diagram illustrating horizontal filtering of N×2N prediction block interpolation with a folded integer pixel and sub-integer pixel processing filter according to an embodiment of the present invention. In this example, it is assumed that N=4, L=8, M=2, and T=6. Hence, when a 4×8 prediction block BK_P is to be processed according to the first processing order (e.g., horizontal filtering→vertical filtering), an 8×1 parallelism integer pixel and sub-integer pixel processing filter (e.g., horizontal filter 115_1) is reconfigured into a 4×2 parallelism integer pixel and sub-integer pixel processing filter for performing horizontal filtering, and another 8×1 parallelism integer pixel and sub-integer pixel processing filter (e.g., vertical filter 115_2) is reconfigured into a 4×2 parallelism integer pixel and sub-integer pixel processing filter for performing vertical filtering. Since the tap number of the employed filter is 6, the calculation of one horizontally filtered sample (denoted by a circle symbol) requires 6 input samples (denoted by square symbols). Since the size of the prediction block is 4×8, integer pixels included in a reference area 502 of a reference frame may be accessed during horizontal filtering of the 4×8 prediction block interpolation. For example, during the first clock cycle of the horizontal filtering of the 4×8 prediction block interpolation, 9×2 input samples are read from a reference frame buffer (e.g., reference frame buffer 122) and fed into the 4×2 parallelism integer pixel and sub-integer pixel processing filter (e.g., horizontal filter 115_1) for calculation of 4×2 filtered samples. As shown in FIG. 5, one 6-tap filter of the 4×2 parallelism integer pixel and sub-integer pixel processing filter (e.g., horizontal filter 115_1) calculates the filtered sample H1 according to input samples P1, P2, P3, P4, P5, P6; one 6-tap filter of the 4×2 parallelism integer pixel and sub-integer pixel processing filter (e.g., horizontal filter 115_1) calculates the filtered sample H2 according to input samples P2, P3, P4, P5, P6, P7; one 6-tap filter of the 4×2 parallelism integer pixel and sub-integer pixel processing filter (e.g., horizontal filter 115_1) calculates the filtered sample H3 according to input samples P3, P4, P5, P6, P7, P8; and one 6-tap filter of the 4×2 parallelism integer pixel and sub-integer pixel processing filter (e.g., horizontal filter 115_1) calculates the filtered sample H4 according to input samples P4, P5, P6, P7, P8, P9. Similarly, the remaining four 6-tap filters of the 4×2 filtered samples (e.g., horizontal filter 115_1) are also active at the same time to calculate 4 filtered samples, respectively.

Though the width of the 4×8 prediction block BK_P is smaller than the number of 6-tap filters used by the 8×1 parallelism integer pixel and sub-integer pixel processing filter (e.g., horizontal filter 115_1), the 8×1 parallelism integer pixel and sub-integer pixel processing filter (e.g., horizontal filter 115_1) is folded to form one 4×2 parallelism integer pixel and sub-integer pixel processing filter, and the 4×2 parallelism integer pixel and sub-integer pixel processing filter is fully utilized to perform horizontal filtering for the 4×8 prediction block BK_P according to a set of 9×2 input samples.

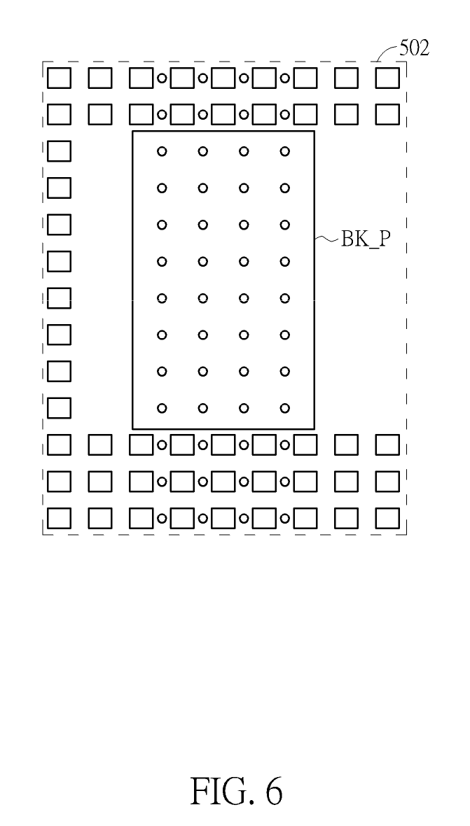

The 4×2 parallelism integer pixel and sub-integer pixel processing filter (e.g., horizontal filter 115_1) may be repeatedly used for calculating following sets of 4×2 filtered samples. For example, during the second clock cycle of the horizontal filtering of the 4×8 prediction block interpolation, a next set of 9×2 input samples may be read from the reference frame buffer (e.g., reference frame buffer 122) and fed into the 4×2 parallelism integer pixel and sub-integer pixel processing filter for calculation of a next set of 4×2 filtered samples. After the horizontal filtering of the 4×8 prediction block interpolation is done, all of the horizontally filtered samples that are processed by the following vertical filtering of the 4×8 prediction block interpolation are generated. FIG. 6 is a diagram illustrating the horizontally filtered samples calculated by the horizontal filtering of the 4×8 prediction block interpolation. In one exemplary implementation, all of the horizontally filtered samples needed by the vertical filtering of the 4×8 prediction block interpolation may be obtained by the 4×2 parallelism integer pixel and sub-integer pixel processing filter that is reconfigured from the 8×1 parallelism integer pixel and sub-integer pixel processing filter. Alternatively, one portion of the horizontally filtered samples needed by the vertical filtering of the 4×8 prediction block interpolation may be obtained by the fully-utilized 4×2 parallelism integer pixel and sub-integer pixel processing filter that is reconfigured from the 8×1 parallelism integer pixel and sub-integer pixel processing filter, and the other portion of the horizontally filtered samples needed by the vertical filtering of the 4×8 prediction block interpolation may be obtained by the partially-utilized 8×1 parallelism integer pixel and sub-integer pixel processing filter. The same objective of improving the filter utilization is achieved.

During the horizontal filtering of the 4×8 prediction block interpolation, another 4×2 parallelism integer pixel and sub-integer pixel processing filter (e.g., vertical filter 115_2) may be active for performing the following vertical filtering of the 4×8 prediction block interpolation according to an output of the horizontal filtering of the 4×8 prediction block interpolation. For example, when the needed horizontally filtered samples (e.g., one set of 4×6 horizontally filtered samples or one set of 4×7 horizontally filtered samples) for parallel processing (e.g., parallel one-row vertical filtering or parallel two-row vertical filtering) are available to another 4×2 parallelism integer pixel and sub-integer pixel processing filter (e.g., vertical filter 115_2), the 4×2 parallelism integer pixel and sub-integer pixel processing filter (e.g., vertical filter 115_2) can start parallel vertical filtering of the horizontally filtered samples.

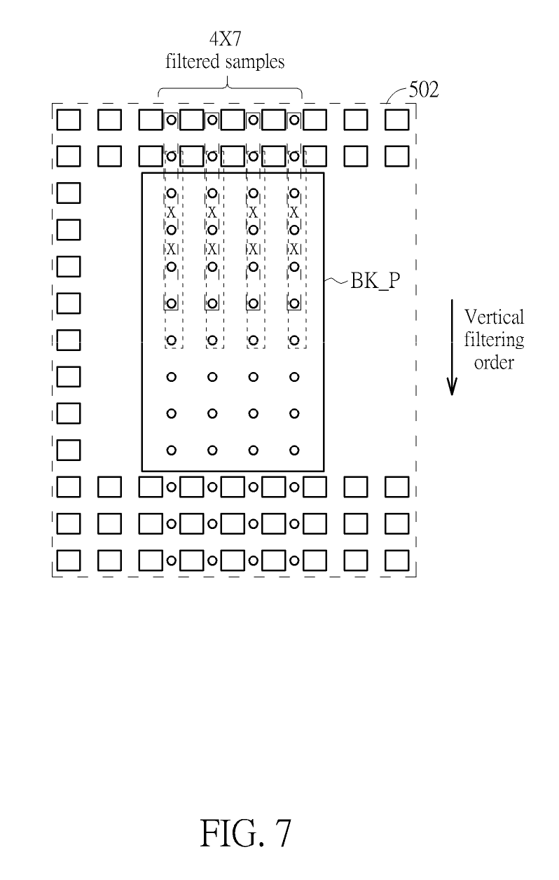

FIG. 7 is a diagram illustrating vertical filtering of N×2N prediction block interpolation with a folded integer pixel and sub-integer pixel processing filter according to an embodiment of the present invention. Since the tap number of the employed filter is 6, the calculation of one vertically filtered sample (denoted by a cross symbol) requires 6 horizontally filtered samples (denoted by circle symbols). For example, during the first clock cycle of the vertical filtering of the 4×8 prediction block interpolation, 4×7 filtered samples (which are obtained by the preceding horizontal filtering of the 4×8 prediction block interpolation) are read from a working buffer and fed into the 4×2 parallelism integer pixel and sub-integer pixel processing filter (e.g., vertical filter 115_2) for calculation of 4×2 vertically filtered samples (which are also samples of the final output).

As shown in FIG. 7, each of the 6-tap filters included in the 4×2 integer pixel and sub-integer pixel processing filter (e.g., vertical filter 115_2) calculates one vertically filtered sample according to 6 horizontally filtered samples at the same pixel column. Though the width of the 4×8 prediction block BK_P is smaller than the number of 6-tap filters used by the 8×1 parallelism integer pixel and sub-integer pixel processing filter (e.g., vertical filter 115_2), the 8×1 parallelism integer pixel and sub-integer pixel processing filter (e.g., vertical filter 115_2) is folded to form one 4×2 parallelism integer pixel and sub-integer pixel processing filter, and the 4×2 parallelism integer pixel and sub-integer pixel processing filter may be fully utilized to perform vertical filtering for the 4×8 prediction block according to a set of 4×7 horizontally filtered samples.

The 4×2 parallelism integer pixel and sub-integer pixel processing filter (e.g., vertical filter 115_2) may be repeatedly used for calculating following sets of 4×2 vertically filtered samples. For example, during the second clock cycle of the vertical filtering of the 4×8 prediction block interpolation, a next set of 4×7 horizontally filtered samples may be read from the working buffer and fed into the 4×2 parallelism integer pixel and sub-integer pixel processing filter (e.g., vertical filter 115_2) for calculation of a next set of 4×2 vertically filtered samples. After the vertical filtering of the 4×8 prediction block interpolation is done, the final output, including all horizontally and vertically filtered samples of the 4×8 prediction block, is generated. In one exemplary implementation, all of the vertically filtered samples calculated during the vertical filtering may be obtained by the 4×2 parallelism integer pixel and sub-integer pixel processing filter that is reconfigured from the 8×1 parallelism integer pixel and sub-integer pixel processing filter. Alternatively, one portion of the vertically filtered samples calculated during the vertical filtering may be obtained by the fully-utilized 4×2 parallelism integer pixel and sub-integer pixel processing filter that is reconfigured from the 8×1 parallelism integer pixel and sub-integer pixel processing filter, and the other portion of the vertically filtered samples calculated during the vertical filtering may be obtained by the partially-utilized 8×1 parallelism integer pixel and sub-integer pixel processing filter. The same objective of improving the filter utilization is achieved.

As mentioned above, the (L/M)×M parallelism integer pixel and sub-integer pixel processing filter reconfigured from the L×1 parallelism integer pixel and sub-integer pixel processing filter (e.g., horizontal filter 115_1/vertical filter 115_2) may be used under a condition that the width of the prediction block to be processed is different from the number of T-tap filters 203_1-203_L (e.g., the width of the prediction block is smaller than the number of T-tap filters 203_1-203_L) for achieving improved filter utilization. However, this is for illustrative purposes only, and is not meant to be a limitation of the present invention. In some embodiments of the present invention, the (L/M)×M parallelism integer pixel and sub-integer pixel processing filter reconfigured from the L×1 parallelism integer pixel and sub-integer pixel processing filter (e.g., horizontal filter 115_1/vertical filter 115_2) may also be used under a condition that the width of the prediction block is equal to the number of T-tap filters 203_1-203_L.

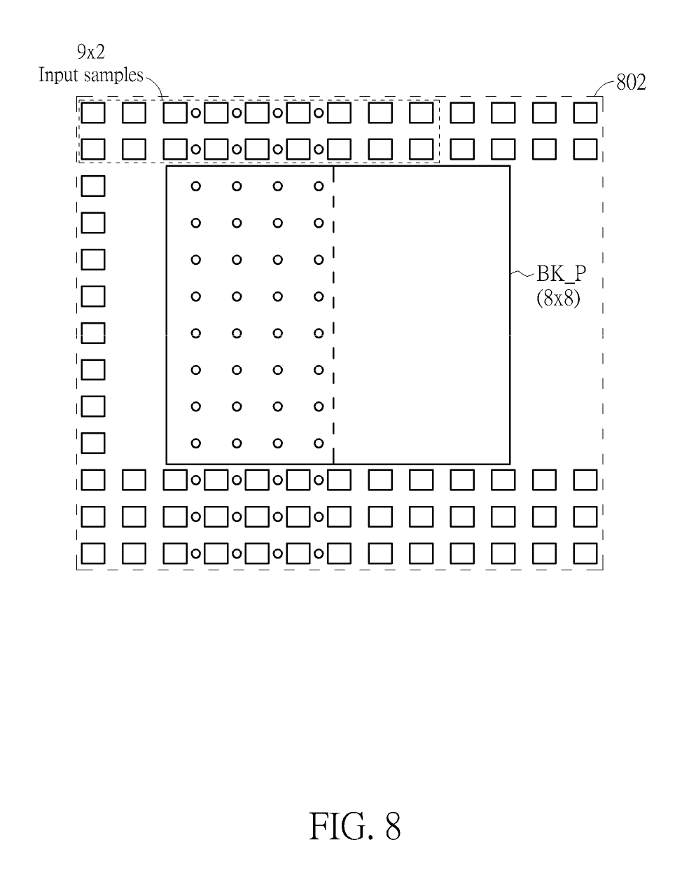

FIG. 8 is a diagram illustrating first horizontal filtering of 2N×2N prediction block interpolation with a folded integer pixel and sub-integer pixel processing filter according to an embodiment of the present invention. In this example, it is assumed that N=4, L=8, M=2, and T=6. Since the tap number of the employed filter is 6, the calculation of one horizontally filtered sample (denoted by a circle symbol) requires 6 input samples (denoted by square symbols). Since the size of the prediction block BK_P is 8×8, integer pixels included in a reference area 802 of a reference frame may be accessed during horizontal filtering of the 8×8 prediction block interpolation. In this embodiment, the 8×8 prediction block interpolation may be accomplished by performing two 4×8 prediction block interpolations one by one, where each 4×8 prediction block interpolation can be performed by using a 4×2 parallelism integer pixel and sub-integer pixel processing filter reconfigured from an 8×1 parallelism integer pixel and sub-integer pixel processing filter. In other words, two rounds of horizontal filtering and vertical filtering of one 4×8 prediction block are required to accomplish horizontal filtering and vertical filtering of one 8×8 prediction blocks.

For example, during the first clock cycle of the horizontal filtering of a first 4×8 prediction block interpolation, 9×2 input samples are read from a reference frame buffer (e.g., reference frame buffer 122) and fed into the 4×2 parallelism integer pixel and sub-integer pixel processing filter (e.g., horizontal filter 115_1) for calculation of 4×2 filtered samples. The 4×2 parallelism integer pixel and sub-integer pixel processing filter (e.g., horizontal filter 115_1) may be repeatedly used for calculating following sets of 4×2 filtered samples. For example, during the second clock cycle of the horizontal filtering of the first 4×8 prediction block interpolation, a next set of 9×2 input samples may be read from the reference frame buffer (e.g., reference frame buffer 122) and fed into the 4×2 parallelism integer pixel and sub-integer pixel processing filter (e.g., horizontal filter 115_1) for calculation of a next set of 4×2 filtered samples. After the horizontal filtering of the first 4×8 prediction block interpolation is done, all of the horizontally filtered samples that are further processed by the following vertical filtering of the first 4×8 prediction block interpolation are generated, as shown in FIG. 8.

During the horizontal filtering of the first 4×8 prediction block interpolation, another 4×2 parallelism integer pixel and sub-integer pixel processing filter (e.g., vertical filter 115_2) may be active for performing the following vertical filtering of the first 4×8 prediction block interpolation according to an output of the horizontal filtering of the first 4×8 prediction block interpolation (e.g., horizontal filter 115_1). For example, when the needed horizontally filtered samples (e.g., one set of 4×6 horizontally filtered samples or one set of 4×7 horizontally filtered samples) for parallel processing (e.g., parallel one-row vertical filtering or parallel two-row vertical filtering) are available to another 4×2 parallelism integer pixel and sub-integer pixel processing filter (e.g., vertical filter 115_2), the 4×2 parallelism integer pixel and sub-integer pixel processing filter (e.g., vertical filter 115_2) can start parallel vertical filtering of the horizontally filtered samples.

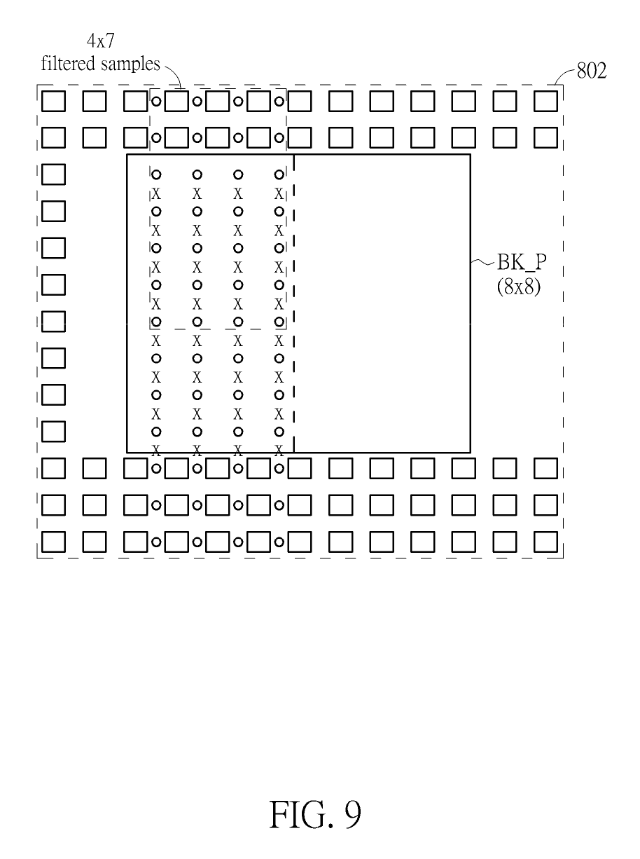

FIG. 9 is a diagram illustrating first vertical filtering of 2N×2N prediction block interpolation with a folded integer pixel and sub-integer pixel processing filter according to an embodiment of the present invention. Since the tap number of the employed filter is 6, the calculation of one vertically filtered sample (denoted by a cross symbol) requires 6 horizontally filtered samples (denoted by circle symbols). For example, during the first clock cycle of the vertical filtering of the first 4×8 prediction block interpolation, 4×7 filtered samples (which are calculated by the preceding horizontal filtering of the first 4×8 prediction block interpolation) are read from a working buffer and fed into the 4×2 parallelism integer pixel and sub-integer pixel processing filter (e.g., vertical filter 115_2) for calculation of 4×2 vertically filtered samples (which are also samples of the final output). As shown in FIG. 9, each of the 6-tap filters included in the 4×2 integer pixel and sub-integer pixel processing filter (e.g., vertical filter 115_2) calculates one vertically filtered sample according to 6 horizontally filtered samples at the same pixel column.

The 4×2 parallelism integer pixel and sub-integer pixel processing filter (e.g., vertical filter 115_2) may be repeatedly used for calculating following sets of 4×2 vertically filtered samples. For example, during the second clock cycle of the vertical filtering of the first 4×8 prediction block interpolation, a next set of 4×7 horizontally filtered samples may be read from the working buffer and fed into the 4×2 parallelism integer pixel and sub-integer pixel processing filter (e.g., vertical filter 115_2) for calculation of a next set of 4×2 vertically filtered samples. After the vertical filtering of the first 4×8 prediction block interpolation is done, a first portion of the final output is generated, as shown in FIG. 9. The first portion includes all horizontally and vertically filtered samples of the first 4×8 prediction block.

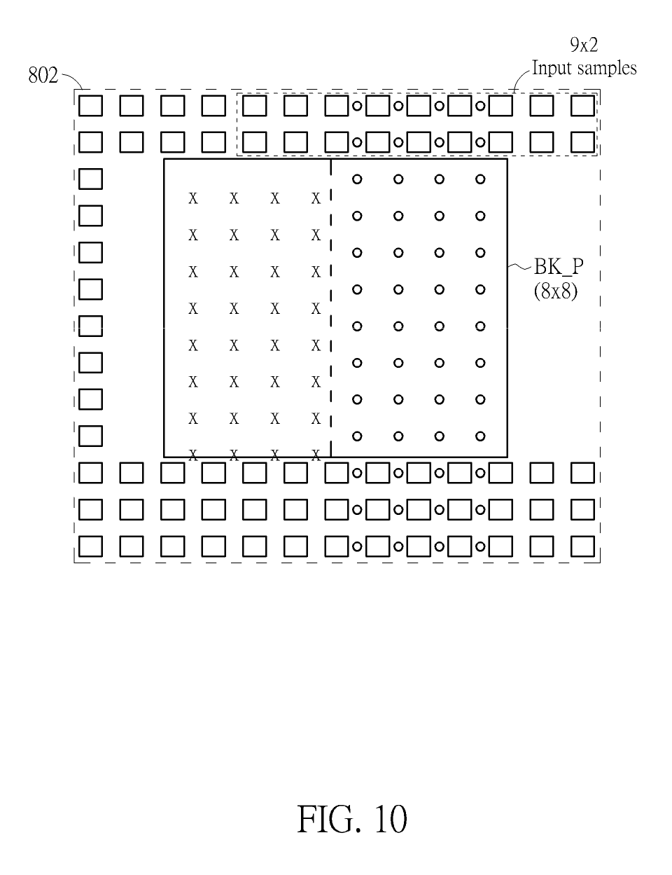

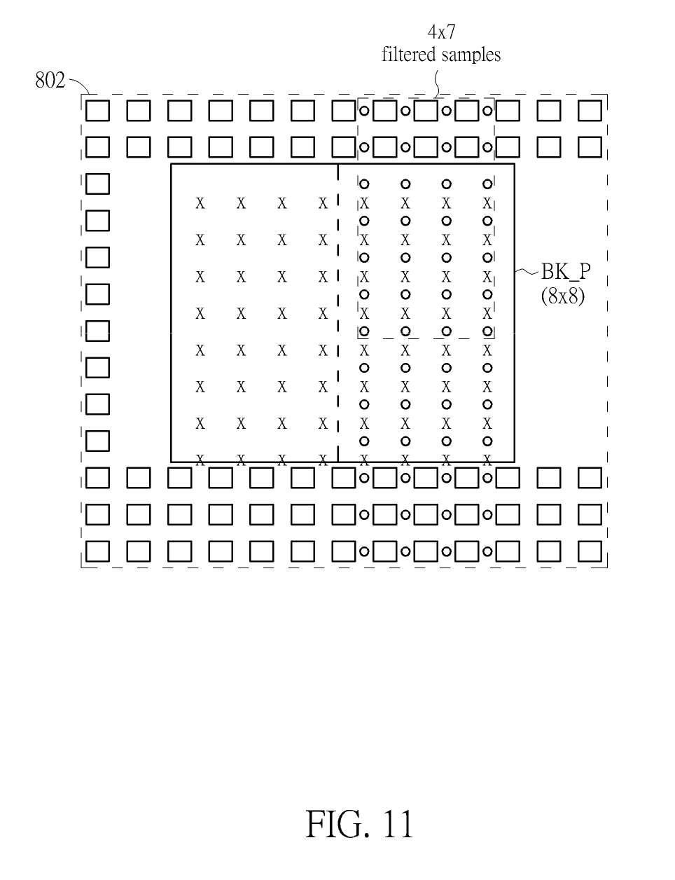

FIG. 10 is a diagram illustrating second horizontal filtering of 2N×2N prediction block interpolation with a folded integer pixel and sub-integer pixel processing filter according to an embodiment of the present invention. FIG. 11 is a diagram illustrating second vertical filtering of 2N×2N prediction block interpolation with a folded integer pixel and sub-integer pixel processing filter according to an embodiment of the present invention. Similarly, the horizontal filtering of the second 4×8 prediction block interpolation and the vertical filtering of the second 4×8 prediction block interpolation are performed one by one. Since the principle of the horizontal filtering of the second 4×8 prediction block interpolation is same as that of the horizontal filtering of the first 4×8 prediction block interpolation and the principle of the vertical filtering of the second 4×8 prediction block interpolation is same as that of the vertical filtering of the first 4×8 prediction block interpolation, further description is omitted here for brevity.

As shown in FIG. 4, one (L/M)×M parallelism integer pixel and sub-integer pixel processing filter (e.g., horizontal filter 115_1) is used to perform interpolation filtering upon input samples (e.g., raw integer pixels) in a pixel row direction, and another (L/M)×M parallelism integer pixel and sub-integer pixel processing filter (e.g., vertical filter 115_2) is used to perform interpolation filtering upon filtered samples (e.g., horizontally filtered integer pixels or horizontally filtered sub-integer pixels) in a pixel column direction to generate a final output (e.g., horizontally and vertically filtered samples of the prediction block). Alternatively, the folded integer pixel and sub-integer pixel processing filter architecture may be applied to an interpolation application that needs to perform the vertical filtering first and then the horizontal filtering.

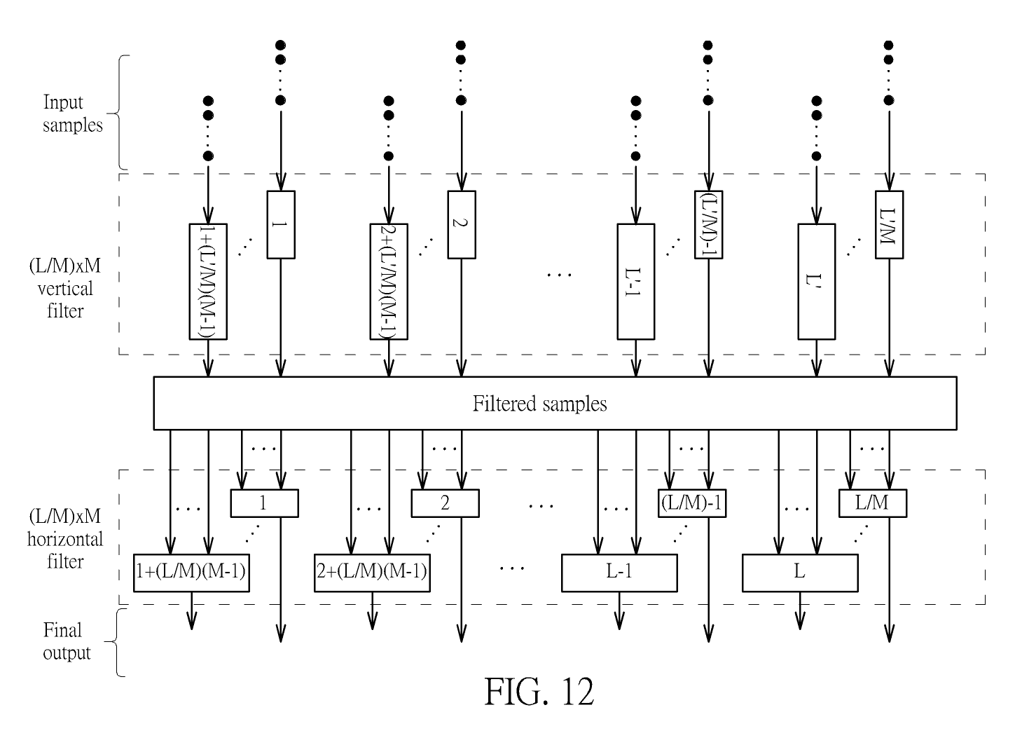

FIG. 12 is a diagram illustrating folded integer pixel and sub-integer pixel processing filter architecture used under a second processing order (e.g., vertical filtering→horizontal filtering) according to an embodiment of the present invention. Since each T-tap filter of a horizontal filter (e.g., horizontal filter 115_1) requires T vertically filtered samples at the same row to generate one horizontally filtered sample, the number of T-tap filters implemented in a vertical filter (e.g., vertical filter 115_2) may be different from the number of T-tap filters implemented in the horizontal filter (e.g., horizontal filter 115_1). In a case where the folded integer pixel and sub-integer pixel processing filter architecture is not supported by the motion compensation circuit 114, the horizontal filter 115_1 may have L×1 T-tap filters, and the vertical filter 115_2 may have [L+(T−1)]×1 T-tap filters. However, in another case where the folded integer pixel and sub-integer pixel processing filter architecture is supported by the motion compensation circuit 114, the horizontal filter 115_1 may have L×1 T-tap filters, and the vertical filter 115_2 may have L′×1 T-tap filters, where L′=L+M*(T−1). In other words, the difference between the number of T-tap filters needed by a fully-utilized vertical filter and the number of T-tap filters needed by a fully-utilized horizontal filter is increased when the value of M is larger, and the difference between the number of T-tap filters needed by a fully-utilized vertical filter and the number of T-tap filters needed by a fully-utilized horizontal filter is decreased when the value of M is smaller. Suppose that the horizontal filter 115_1 (e.g., L×1 parallelism integer pixel and sub-integer pixel processing filter) is designed to be folded into an (L/M)×M parallelism integer pixel and sub-integer pixel processing filter that can be fully utilized under a condition that a prediction block has a width W1 not smaller than L/M (i.e., W1≧L/M), and the vertical filter 115_2 (e.g., L′×1 parallelism integer pixel and sub-integer pixel processing filter) is designed to be folded into an (L′/M)×M parallelism integer pixel and sub-integer pixel processing filter that can also be fully utilized under the same condition that the prediction block has the width W1 not smaller than L/M (i.e., W1≧L/M). When the vertical filter 115_2 (e.g., L′×1 parallelism integer pixel and sub-integer pixel processing filter) and the horizontal filter 115_1 (e.g., L×1 parallelism integer pixel and sub-integer pixel processing filter) are used to process a prediction block with a width W2 smaller than W1 (i.e., W2<W1), only a portion of the horizontal filter 115_1 (e.g., P×1 parallelism integer pixel and sub-integer pixel processing filter, where P=W2×M<L) can be allowed to be folded into a (P/M)×M parallelism integer pixel and sub-integer pixel processing filter fully utilized under the prediction block width W2, and only a portion of the vertical filter 115_2 (e.g., Q×1 parallelism integer pixel and sub-integer pixel processing filter, where Q=P+M*(T−1)<L′) can be allowed to be folded into a (Q/M)×M parallelism integer pixel and sub-integer pixel processing filter fully utilized under the same prediction block width W2. In other words, when a prediction block has a first width (e.g., W1), the horizontal filter 115_1 and the vertical filter 115_2 may be fully used according to the folded integer pixel and sub-integer pixel processing filter architecture; and when a prediction block has a second width (e.g., W2), the horizontal filter 115_1 and the vertical filter 115_2 may be partially used according to the folded integer pixel and sub-integer pixel processing filter architecture. However, this is for illustrative purposes only, and is not meant to be a limitation of the present invention.

Although the number of T-tap filters implemented in a vertical filter (e.g., vertical filter 115_2) may be different from the number of T-tap filters implemented in a horizontal filter (e.g., horizontal filter 115_1) when the vertical filter and the horizontal filter operate under the second processing order (e.g., vertical filtering→horizontal filtering), the principle of the folded integer pixel and sub-integer pixel processing filter architecture shown in FIG. 12 is similar to that of the folded integer pixel and sub-integer pixel processing filter architecture shown in FIG. 4.

Suppose that the horizontal filter 115_1 is designed to have L×1 T-tap filters implemented therein, the vertical filter 115_2 is designed to have L′×1 T-tap filters implemented therein, and a width of a prediction block to be processed is W1, where L′=L+M*(T−1) and W1≧L/M. To achieve full utilization of the horizontal filter 115_1 and the vertical filter 115_2, the filter configuration circuit 304 of the horizontal filter 115_1 reconfigures the L×1 parallelism integer pixel and sub-integer pixel processing filter 302 into an (L/M)×M parallelism integer pixel and sub-integer pixel processing filter according to a width of a prediction block to be processed, and the filter configuration circuit of the vertical filter 115_2 also reconfigures the L′×1 parallelism integer pixel and sub-integer pixel processing filter into an (L′/M)×M parallelism integer pixel and sub-integer pixel processing filter according to the width of the prediction block to be processed. In this embodiment, the (L′/M)×M parallelism integer pixel and sub-integer pixel processing filter is used to serve as an (L′/M)×M vertical filter for performing interpolation filtering upon input samples (e.g., raw integer pixels) in a pixel column direction, and the (L/M)×M parallelism integer pixel and sub-integer pixel processing filter is used to serve as an (L/M)×M horizontal filter for performing interpolation filtering upon filtered samples (e.g., vertically filtered integer pixels or vertically filtered sub-integer pixels) in a pixel row direction to generate a final output (e.g., vertically and horizontally filtered samples of the prediction block). Since a person skilled in the art can readily understand the principle of the folded integer pixel and sub-integer pixel processing filter architecture shown in FIG. 12 after reading above paragraphs directed to the folded integer pixel and sub-integer pixel processing filter architecture shown in FIG. 4, further description is omitted here for brevity.

As mentioned above, the folded integer pixel and sub-integer pixel processing filter architecture may be employed for parallel calculation of filtered samples associated with the same prediction block. Alternatively, based on widths of multiple prediction blocks, the L×1 parallelism integer pixel and sub-integer pixel processing filter 302 (e.g., horizontal filter 115_1/vertical filter 115_2) may be reconfigured by the filter configuration circuit 304 to have composed integer pixel and sub-integer pixel processing filter architecture for parallel calculation of filtered samples associated with different prediction blocks.

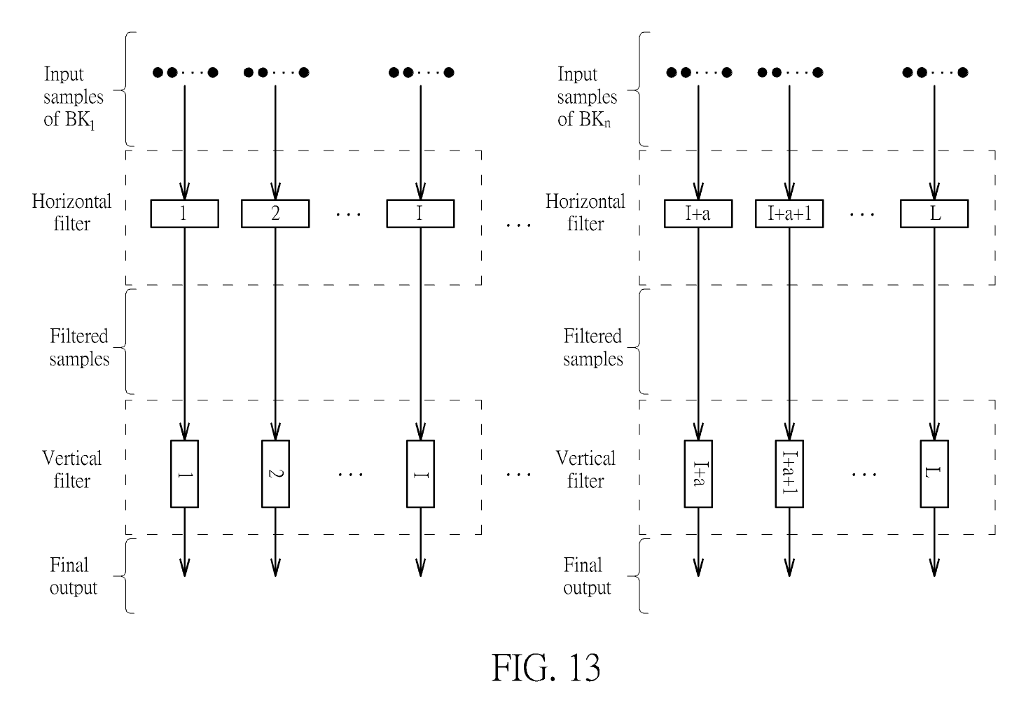

FIG. 13 is a diagram illustrating composed integer pixel and sub-integer pixel processing filter architecture used under a first processing order (e.g., horizontal filtering→vertical filtering) according to an embodiment of the present invention. The filter configuration circuit 304 reconfigures the L×1 parallelism integer pixel and sub-integer pixel processing filter 302 into a plurality of parallelism integer pixel and sub-integer pixel processing filters according to widths of a plurality of prediction blocks, respectively. The parallelism integer pixel and sub-integer pixel processing filters are arranged to calculate filtered samples associated with the prediction blocks in a parallel fashion, and each of the parallelism integer pixel and sub-integer pixel processing filters is arranged to calculate filtered samples at the same pixel line (e.g., the same pixel row for horizontal filtering or the same pixel row for vertical filtering).

In this embodiment, each of horizontal filter 115_1 and vertical filter 115_2 shown in FIG. 1 may be implemented using the reconfigurable interpolation filter 300 shown in FIG. 3. As shown in FIG. 13, each of the parallelism integer pixel and sub-integer pixel processing filters composed in the horizontal filter 115_1 is used to serve as one horizontal filter for performing interpolation filtering upon input samples (e.g., raw integer pixels) in a pixel row direction, and each of the parallelism integer pixel and sub-integer pixel processing filters composed in the vertical filter 115_2 is used to serve as one vertical filter for performing interpolation filtering upon filtered samples (e.g., horizontally filtered integer pixels or horizontally filtered sub-integer pixels) in a pixel column direction to generate a final output (e.g., horizontally and vertically filtered samples of a prediction block).

Each of the parallelism integer pixel and sub-integer pixel processing filters is a W×1 parallelism integer pixel and sub-integer pixel processing filter composed of W filters selected from the T-tap filters 203_1-203_L, where W depends on the width of one prediction block. As shown in FIG. 13, the first parallelism integer pixel and sub-integer pixel processing filter is composed of T-tap filters 203_i, where i=1, 2, . . . I, and I depends on the width of the first prediction block BK₁; and the last parallelism integer pixel and sub-integer pixel processing filter is composed of T-tap filters 203_i, where i=I+a, I+a+1, . . . L, and (I+a) depends on the width of the last prediction block BKₙ. A value of the variable “a” shown in FIG. 13 depends on the number of T-tap filters possessed by all intermediate parallelism integer pixel and sub-integer pixel processing filters (not shown) between the first parallelism integer pixel and sub-integer pixel processing filter and the last parallelism integer pixel and sub-integer pixel processing filter. For example, if there is no intermediate parallelism integer pixel and sub-integer pixel processing filter created by the composed integer pixel and sub-integer pixel processing filter architecture, the value of the variable “a” is set by 1. Specifically, numbers of T-tap filters included in respective parallelism integer pixel and sub-integer pixel processing filters may be same or different, depending upon widths of different prediction blocks that can be processed in parallel. For better understanding of technical features of the composed integer pixel and sub-integer pixel processing filter architecture, several examples are discussed as below.

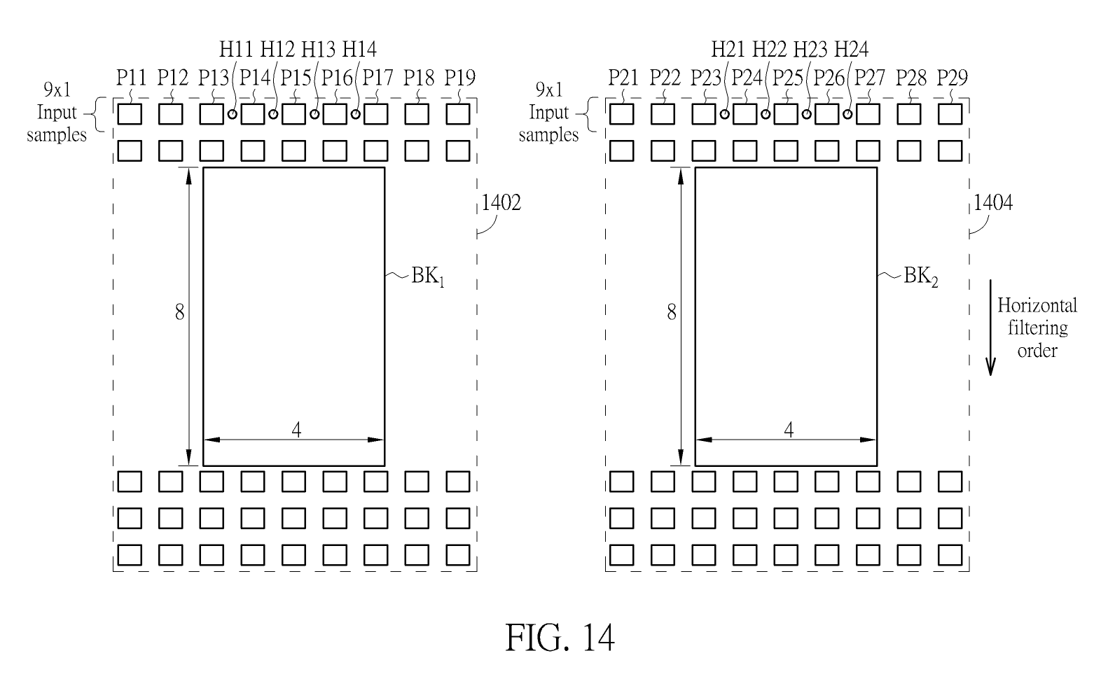

FIG. 14 is a diagram illustrating horizontal filtering of two N×2N prediction block interpolations with two composed integer pixel and sub-integer pixel processing filters according to an embodiment of the present invention. It should be noted that the composed integer pixel and sub-integer pixel processing filter architecture may be employed to process multiple prediction blocks in parallel, where a sum of widths of the multiple prediction blocks may be equal to or smaller than the number of T-tap filters included in an L×1 parallelism integer pixel and sub-integer pixel processing filter. In this example, it is assumed that N=4, L=8, n=2 and T=6. Hence, a sum of widths of two 4×8 prediction blocks BK₁ and BK₂ is equal to L. When two 4×8 prediction blocks BK₁ and BK₂ are to be processed under the first processing order (e.g., horizontal filtering→vertical filtering), an 8×1 parallelism integer pixel and sub-integer pixel processing filter (e.g., horizontal filter 115_1) is reconfigured into two 4×1 parallelism integer pixel and sub-integer pixel processing filters, each used for performing horizontal filtering, and another 8×1 parallelism integer pixel and sub-integer pixel processing filter (e.g., vertical filter 115_2) is reconfigured into two 4×1 parallelism integer pixel and sub-integer pixel processing filters, each used for performing vertical filtering. Since the tap number of the employed filter is 6, the calculation of one horizontally filtered sample (denoted by a circle symbol) requires 6 input samples (denoted by square symbols). Since the size of each of the prediction blocks BK₁ and BK₂ is 4×8, integer pixels included in a reference area 1402 of a reference frame may be accessed during horizontal filtering of a first 4×8 prediction block interpolation, and integer pixels included in a reference area 1404 of a reference frame may be accessed during horizontal filtering of a second 4×8 prediction block interpolation, where the first 4×8 prediction block interpolation is performed for the 4×8 prediction block BK₁, and the second 4×8 prediction block interpolation is performed for the 4×8 prediction block BK₂.

For example, during the first clock cycle of horizontal filtering of two 4×8 prediction block interpolations, 9×1 input samples are read from a reference frame buffer (e.g., reference frame buffer 122) and fed into a first 4×1 parallelism integer pixel and sub-integer pixel processing filter (which is a first part of the horizontal filter 115_1) for calculation of 4×1 filtered samples, and another 9×1 input samples are read from the reference frame buffer (e.g., reference frame buffer 122) and fed into a second 4×1 parallelism integer pixel and sub-integer pixel processing filter (which is a second part of the horizontal filter 115_1) for calculation of another 4×1 filtered samples. As shown in FIG. 14, one 6-tap filter of the first 4×1 parallelism integer pixel and sub-integer pixel processing filter calculates the filtered sample H11 according to input samples P11, P12, P13, P14, P15, P16; one 6-tap filter of the first 4×1 parallelism integer pixel and sub-integer pixel processing filter calculates the filtered sample H12 according to input samples P12, P13, P14, P15, P16, P17; one 6-tap filter of the first 4×1 parallelism integer pixel and sub-integer pixel processing filter calculates the filtered sample H13 according to input samples P13, P14, P15, P16, P17, P18; and one 6-tap filter of the first 4×1 parallelism integer pixel and sub-integer pixel processing filter calculates the filtered sample H14 according to input samples P14, P15, P16, P17, P18, P19. In addition, one 6-tap filter of the second 4×1 parallelism integer pixel and sub-integer pixel processing filter calculates the filtered sample H21 according to input samples P21, P22, P23, P24, P25, P26; one 6-tap filter of the second 4×1 parallelism integer pixel and sub-integer pixel processing filter calculates the filtered sample H22 according to input samples P22, P23, P24, P25, P26, P27; one 6-tap filter of the second 4×1 parallelism integer pixel and sub-integer pixel processing filter calculates the filtered sample H23 according to input samples P23, P24, P25, P26, P27, P28; and one 6-tap filter of the second 4×1 parallelism integer pixel and sub-integer pixel processing filter calculates the filtered sample H24 according to input samples P24, P25, P26, P27, P28, P29.

Though the width of the 4×8 prediction block BK₁ is smaller than the number of 6-tap filters used by the 8×1 parallelism integer pixel and sub-integer pixel processing filter (e.g., horizontal filter 115_1) and the width of the 4×8 prediction block BK₂ is also smaller than the number of 6-tap filters used by the 8×1 parallelism integer pixel and sub-integer pixel processing filter (e.g., horizontal filter 115_1), the 8×1 parallelism integer pixel and sub-integer pixel processing filter (e.g., horizontal filter 115_1) is split to form two 4×1 parallelism integer pixel and sub-integer pixel processing filters, and the two 4×1 parallelism integer pixel and sub-integer pixel processing filters are fully utilized to perform horizontal filtering for 4×8 prediction blocks BK₁ and BK₂ according to two sets of 9×1 input samples.

Each of the two 4×1 parallelism integer pixel and sub-integer pixel processing filters (which are composed in the horizontal filter 115_1) may be repeatedly used for calculating following sets of 4×1 filtered samples. For example, during the second clock cycle of the horizontal filtering of the two 4×8 prediction block interpolations, a next set of 9×1 input samples may be read from the reference frame buffer (e.g., reference frame buffer 122) and fed into the first 4×1 parallelism integer pixel and sub-integer pixel processing filter (which is the first part of the horizontal filter 115_1) for calculation of a next set of 4×1 filtered samples, and a next set of 9×1 input samples may be read from the reference frame buffer (e.g., reference frame buffer 122) and fed into the second 4×1 parallelism integer pixel and sub-integer pixel processing filter (which is the second part of the horizontal filter 115_1) for calculation of a next set of 4×1 filtered samples. After the horizontal filtering of the two 4×8 prediction block interpolations is done, all of the horizontally filtered samples that are further processed by the following vertical filtering of the two 4×8 prediction block interpolations are generated.

In this embodiment, another two 4×1 parallelism integer pixel and sub-integer pixel processing filters (which are composed in the vertical filter 115_2) may be used for performing the vertical filtering of the two 4×8 prediction block interpolations according to an output of the horizontal filtering of the two 4×8 prediction block interpolations. For example, during the parallel horizontal filtering of the 4×8 prediction blocks BK₁ and BK₂, the two 4×1 parallelism integer pixel and sub-integer pixel processing filters (which are composed in the vertical filter 115_2) may be active for performing the following parallel vertical filtering of the 4×8 prediction blocks BK₁ and BK₂ according to an output of the parallel horizontal filtering of the 4×8 prediction blocks BK₁ and BK₂. For example, when the needed horizontally filtered samples (e.g., one set of 4×6 horizontally filtered samples) for parallel vertical processing are available to a first 4×1 parallelism integer pixel and sub-integer pixel processing filter (which is a first part of the vertical filter 115_2), the first 4×1 parallelism integer pixel and sub-integer pixel processing filter (which is the first part of the vertical filter 115_2) can start parallel vertical filtering of the horizontally filtered samples; and when the needed horizontally filtered samples (e.g., one set of 4×6 horizontally filtered samples) for parallel vertical processing are available to a second 4×1 parallelism integer pixel and sub-integer pixel processing filter (which is a second part of the vertical filter 115_2), the second 4×1 parallelism integer pixel and sub-integer pixel processing filter (which is the second part of the vertical filter 115_2) can start parallel vertical filtering of the horizontally filtered samples.

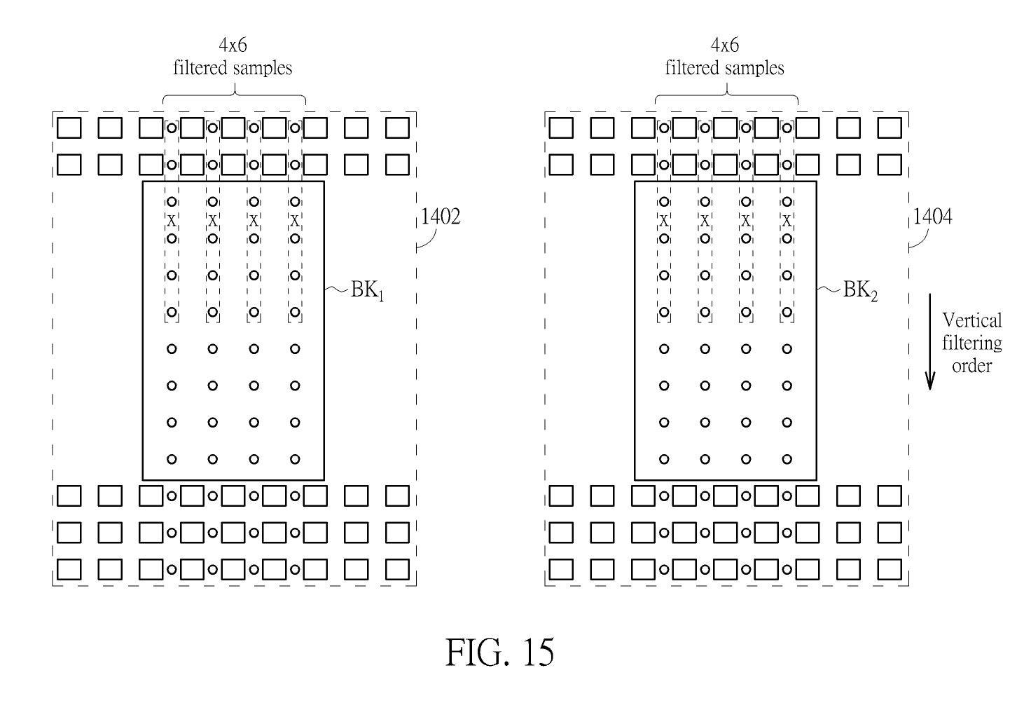

FIG. 15 is a diagram illustrating vertical filtering of two parallel N×2N prediction block interpolations with two composed integer pixel and sub-integer pixel processing filters according to an embodiment of the present invention. Since the tap number of the employed filter is 6, the calculation of one vertically filtered sample (denoted by a cross symbol) requires 6 horizontally filtered samples (denoted by circle symbols). For example, during the first clock cycle of the vertical filtering of the two 4×8 prediction block interpolations, 4×6 filtered samples (which are calculated by the preceding horizontal filtering of the two 4×8 prediction block interpolations) are read from a working buffer and fed into the first 4×1 parallelism integer pixel and sub-integer pixel processing filter (which is the first part of the vertical filter 115_2) for calculation of 4×1 vertically filtered samples (which are also samples of the final output of the 4×8 prediction block BK₁), and 4×6 filtered samples (which are calculated by the preceding horizontal filtering of the two 4×8 prediction block interpolations) are read from the working buffer and fed into the second 4×1 parallelism integer pixel and sub-integer pixel processing filter (which is the second part of the vertical filter 115_2) for calculation of 4×1 vertically filtered samples (which are also samples of the final output of the 4×8 prediction block BK₂). As shown in FIG. 15, each of the 6-tap filters included in the 4×1 integer pixel and sub-integer pixel processing filters calculates one vertically filtered sample according to 6 horizontally filtered samples at the same pixel column.

Though the width of the 4×8 prediction block BK₁ is smaller than the number of 6-tap filters used by the 8×1 parallelism integer pixel and sub-integer pixel processing filter (e.g., vertical filter 115_2) and the width of the 4×8 prediction block BK₂ is also smaller than the number of 6-tap filters used by the 8×1 parallelism integer pixel and sub-integer pixel processing filter (e.g., vertical filter 115_2), the 8×1 parallelism integer pixel and sub-integer pixel processing filter (e.g., vertical filter 115_2) is split to form two 4×1 parallelism integer pixel and sub-integer pixel processing filters, and the two 4×1 parallelism integer pixel and sub-integer pixel processing filters are fully utilized to perform vertical filtering for 4×8 prediction blocks BK₁ and BK₂ according to two sets of 4×6 filtered samples (particularly, 4×6 horizontally filtered samples obtained by preceding horizontal filtering).

Each of the two 4×1 parallelism integer pixel and sub-integer pixel processing filters (which are composed in the vertical filter 115_2) may be repeatedly used for calculating following sets of 4×1 vertically filtered samples. For example, during the second clock cycle of the vertical filtering of the two 4×8 prediction block interpolations, a next set of 4×6 horizontally filtered samples may be read from the working buffer and fed into the first 4×1 parallelism integer pixel and sub-integer pixel processing filter (which is the first part of the vertical filter 115_2) for calculation of a next set of 4×1 vertically filtered samples, and a next set of 4×6 horizontally filtered samples may be read from the working buffer and fed into the second 4×1 parallelism integer pixel and sub-integer pixel processing filter (which is the second part of the vertical filter 115_2) for calculation of a next set of 4×1 vertically filtered samples. After the vertical filtering of the two 4×8 prediction block interpolations is done, two final outputs (which include all horizontally and vertically filtered samples of the 4×8 prediction blocks BK₁ and BK₂) are generated.

Since the sum of widths of different prediction blocks is equal to L (i.e., the number of filters included in the L×1 parallelism integer pixel and sub-integer pixel processing filter), the L×1 parallelism integer pixel and sub-integer pixel processing filter (e.g., horizontal filter 115_1/vertical filter 115_2) can be split to form multiple parallelism integer pixel and sub-integer pixel processing filters, each used to calculate filtered samples at the same pixel line (e.g., the same pixel row or the same pixel column). For example, supposing that widths of different prediction blocks BK₁-BKₙ are W₁, W₂, . . . , Wₙ the L×1 parallelism integer pixel and sub-integer pixel processing filter (e.g., horizontal filter 115_1/vertical filter 115_2) is split into one W₁×1 parallelism integer pixel and sub-integer pixel processing filter, one W₂×1 parallelism integer pixel and sub-integer pixel processing filter, . . . one Wₙ×1 parallelism integer pixel and sub-integer pixel processing filter, where W₁+W₂+ . . . +Wₙ=L. With regard to the example shown in FIG. 14 and FIG. 15, widths of two prediction blocks (i.e., 4×8 prediction blocks BK₁ and BK₂) are same. Hence, the composed integer pixel and sub-integer pixel processing filter architecture may be applied to prediction blocks having multiple prediction blocks with the same width. Alternatively, the composed integer pixel and sub-integer pixel processing filter architecture may be applied to prediction blocks having multiple prediction blocks with different widths (e.g., two prediction blocks with nL×2N partition type).

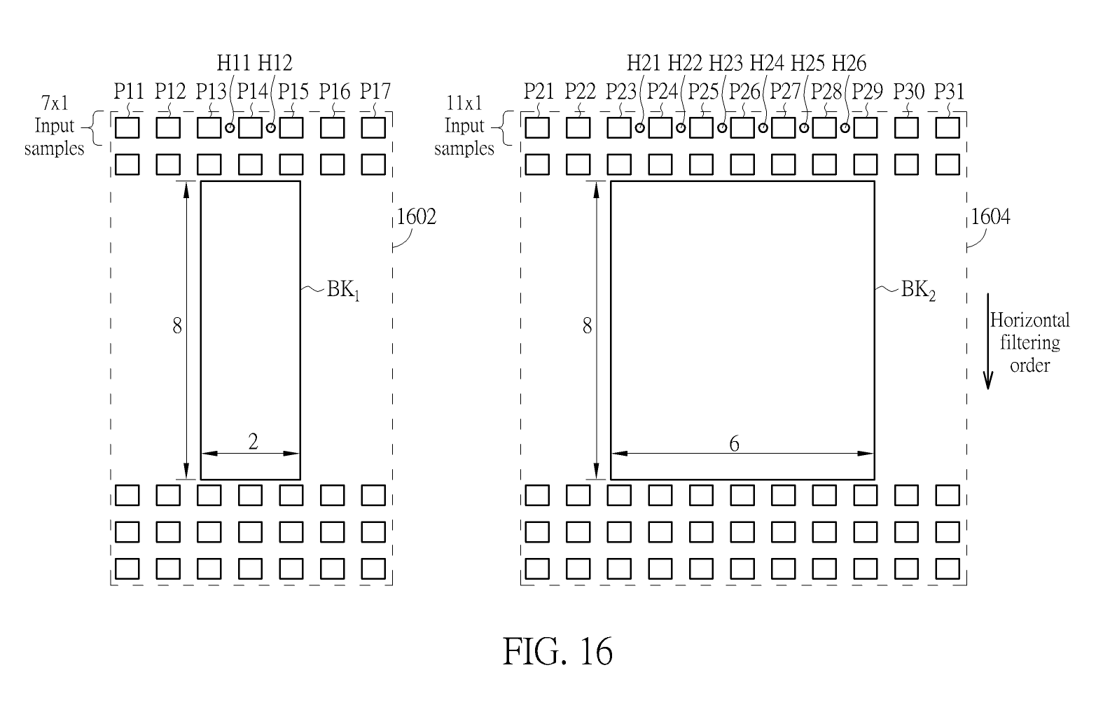

FIG. 16 is a diagram illustrating horizontal filtering of two nL×2N prediction block interpolations with two composed integer pixel and sub-integer pixel processing filters according to an embodiment of the present invention. In this example, it is assumed that N=4, L=8, n=2 and T=6. Hence, a sum of widths of one 2×8 prediction block BK₁ and one 6×8 prediction block BK₂ is equal to L. When the 2×8 prediction block BK₁ and the 6×8 prediction block BK₂ are to be processed under the first processing order (e.g., horizontal filtering→vertical filtering), an 8×1 parallelism integer pixel and sub-integer pixel processing filter (e.g., horizontal filter 115_1) is reconfigured into one 2×1 parallelism integer pixel and sub-integer pixel processing filter and one 6×1 parallelism integer pixel and sub-integer pixel processing filter, each used for performing horizontal filtering, and another 8×1 parallelism integer pixel and sub-integer pixel processing filter (e.g., vertical filter 115_2) is reconfigured into one 2×1 parallelism integer pixel and sub-integer pixel processing filter and one 6×1 parallelism integer pixel and sub-integer pixel processing filter, each used for performing vertical filtering. Since the tap number of the employed filter is 6, the calculation of one horizontally filtered sample (denoted by a circle symbol) requires 6 input samples (denoted by square symbols). Since sizes of prediction blocks BK₁ and BK₂ are 2×8 and 6×8, respectively, integer pixels included in a reference area 1602 of a reference frame may be accessed during horizontal filtering of the 2×8 prediction block interpolation, and integer pixels included in a reference area 1604 of a reference frame may be accessed during horizontal filtering of the 6×8 prediction block interpolation. For example, during the first clock cycle of horizontal filtering of 2×8 prediction block interpolation and 6×8 prediction block interpolation, 7×1 input samples are read from a reference frame buffer (e.g., reference frame buffer 122) and fed into the 2×1 parallelism integer pixel and sub-integer pixel processing filter (which is a first part of the horizontal filter 115_1) for calculation of 2×1 filtered samples, and 11×1 input samples are read from the reference frame buffer (e.g., reference frame buffer 122) and fed into the 6×1 parallelism integer pixel and sub-integer pixel processing filter (which is a second part of the horizontal filter 115_1) for calculation of 6×1 filtered samples. As shown in FIG. 16, one 6-tap filter of the 2×1 parallelism integer pixel and sub-integer pixel processing filter calculates the filtered sample H11 according to input samples P11, P12, P13, P14, P15, P16, and the other 6-tap filter of the 2×1 parallelism integer pixel and sub-integer pixel processing filter calculates the filtered sample H12 according to input samples P12, P13, P14, P15, P16, P17. In addition, one 6-tap filter of the 6×1 parallelism integer pixel and sub-integer pixel processing filter calculates the filtered sample H21 according to input samples P21, P22, P23, P24, P25, P26; one 6-tap filter of the 8×1 parallelism integer pixel and sub-integer pixel processing filter calculates the filtered sample H22 according to input samples P22, P23, P24, P25, P26, P27; one 6-tap filter of the 6×1 parallelism integer pixel and sub-integer pixel processing filter calculates the filtered sample H23 according to input samples P23, P24, P25, P26, P27, P28; one 6-tap filter of the 6×1 parallelism integer pixel and sub-integer pixel processing filter calculates the filtered sample H24 according to input samples P24, P25, P26, P27, P28, P29; one 6-tap filter of the 6×1 parallelism integer pixel and sub-integer pixel processing filter calculates the filtered sample H25 according to input samples P25, P26, P27, P28, P29, P30; and one 6-tap filter of the 6×1 parallelism integer pixel and sub-integer pixel processing filter calculates the filtered sample H26 according to input samples P25, P26, P27, P28, P29, P30, P31.

Though the width of the 2×8 prediction block BK₁ is smaller than the number of 6-tap filters used by the 8×1 parallelism integer pixel and sub-integer pixel processing filter (e.g., horizontal filter 115_1) and the width of the 6×8 prediction block BK₂ is also smaller than the number of 6-tap filters used by the 8×1 parallelism integer pixel and sub-integer pixel processing filter (e.g., horizontal filter 115_1), the 8×1 parallelism integer pixel and sub-integer pixel processing filter (e.g., horizontal filter 115_1) is split to form one 2×1 parallelism integer pixel and sub-integer pixel processing filter and one 6×1 parallelism integer pixel and sub-integer pixel processing filter, and the 2×1 parallelism integer pixel and sub-integer pixel processing filter and the 6×1 parallelism integer pixel and sub-integer pixel processing filter are fully utilized to perform horizontal filtering for prediction blocks BK₁ and BK₂ according to a set of 7×1 input samples and a set of 11×1 input samples.

The 2×1 parallelism integer pixel and sub-integer pixel processing filter (which is the first part of the horizontal filter 115_1) may be repeatedly used for calculating following sets of 2×1 filtered samples, and the 6×1 parallelism integer pixel and sub-integer pixel processing filter (which is the second part of the horizontal filter 115_1) may be repeatedly used for calculating following sets of 6×1 filtered samples. For example, during the second clock cycle of the horizontal filtering of 2×8 prediction block interpolation and 6×8 prediction block interpolation, a next set of 7×1 input samples may be read from the reference frame buffer (e.g., reference frame buffer 122) and fed into the 2×1 parallelism integer pixel and sub-integer pixel processing filter (which is the first part of the horizontal filter 115_1) for calculation of a next set of 2×1 filtered samples, and a next set of 11×1 input samples may be read from the reference frame buffer (e.g., reference frame buffer 122) and fed into the 6×1 parallelism integer pixel and sub-integer pixel processing filter (which is the second part of the horizontal filter 115_1) for calculation of a next set of 6×1 filtered samples. After the horizontal filtering of 2×8 prediction block interpolation and 6×8 prediction block interpolation is done, all of the horizontally filtered samples that are further processed by the following vertical filtering of 2×8 prediction block interpolation and 6×8 prediction block interpolation are generated.

In this embodiment, another 2×1 parallelism integer pixel and sub-integer pixel processing filter and another 6×1 parallelism integer pixel and sub-integer pixel processing filter (which are composed in the vertical filter 115_2) may be used for performing the vertical filtering of parallel 2×8 prediction block interpolation and 6×8 prediction block interpolation according to an output of the horizontal filtering of parallel 2×8 prediction block interpolation and 6×8 prediction block interpolation. For example, during the parallel horizontal filtering of the 2×8 prediction block BK₁ and the 6×8 prediction block BK₂, the 2×1 parallelism integer pixel and sub-integer pixel processing filter and the 6×1 parallelism integer pixel and sub-integer pixel processing filter (which are composed in the vertical filter 115_2) may be active for performing the following parallel vertical filtering of the 2×8 prediction block BK₁ and the 6×8 prediction block BK₂ according to an output of the parallel horizontal filtering of the 2×8 prediction block BK₁ and the 6×8 prediction block BK₂. For example, when the needed horizontally filtered samples (e.g., one set of 2×6 horizontally filtered samples) for parallel vertical processing are available to the 2×1 parallelism integer pixel and sub-integer pixel processing filter (which is the first part of the vertical filter 115_2), the 2×1 parallelism integer pixel and sub-integer pixel processing filter (which is the first part of the vertical filter 115_2) can start parallel vertical filtering of the horizontally filtered samples; and when the needed horizontally filtered samples (e.g., one set of 6×6 horizontally filtered samples) for parallel vertical processing are available to the 6×1 parallelism integer pixel and sub-integer pixel processing filter (which is the second part of the vertical filter 115_2), the 6×1 parallelism integer pixel and sub-integer pixel processing filter (which is the second part of the vertical filter 115_2) can start parallel vertical filtering of the horizontally filtered samples.

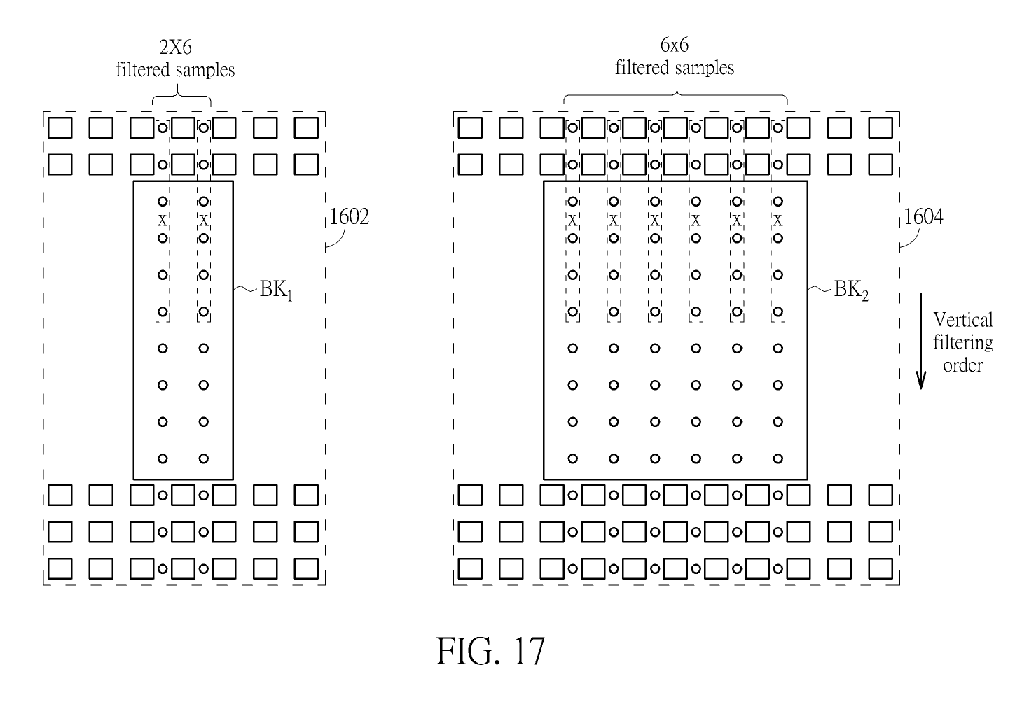

FIG. 17 is a diagram illustrating vertical filtering of 2×8 prediction block interpolation and 6×8 prediction block interpolation with two composed integer pixel and sub-integer pixel processing filters according to an embodiment of the present invention. Since the tap number of the employed filter is 6, the calculation of one vertically filtered sample (denoted by a cross symbol) requires 6 horizontally filtered samples (denoted by circle symbols). For example, during the first clock cycle of the vertical filtering of 2×8 prediction block interpolation and 6×8 prediction block interpolation, 2×6 filtered samples (which are calculated by the preceding horizontal filtering of 2×8 prediction block interpolation) are read from a working buffer and fed into the 2×1 parallelism integer pixel and sub-integer pixel processing filter (which is the first part of the vertical filter 115_2) for calculation of 2×1 vertically filtered samples (which are also samples of the final output of the 2×8 prediction block BK₁), and 6×6 filtered samples (which are calculated by the preceding horizontal filtering of 6×8 prediction block interpolation) are read from the working buffer and fed into the 6×1 parallelism integer pixel and sub-integer pixel processing filter (which is the second part of the vertical filter 115_2) for calculation of 6×1 vertically filtered samples (which are also samples of the final output of the 6×8 prediction block BK₂). As shown in FIG. 17, each of the 6-tap filters included in the 2×1 integer pixel and sub-integer pixel processing filter and the 6×1 integer pixel and sub-integer pixel processing filter calculates one vertically filtered sample according to 6 horizontally filtered samples at the same pixel column.

Though the width of the 2×8 prediction block BK₁ is smaller than the number of 6-tap filters used by the 8×1 parallelism integer pixel and sub-integer pixel processing filter (e.g., vertical filter 115_2) and the width of the 6×8 prediction block BK₂ is also smaller than the number of 6-tap filters used by the 8×1 parallelism integer pixel and sub-integer pixel processing filter (e.g., vertical filter 115_2), the 8×1 parallelism integer pixel and sub-integer pixel processing filter (e.g., vertical filter 115_2) is split to form one 2×1 parallelism integer pixel and sub-integer pixel processing filter and one 6×1 parallelism integer pixel and sub-integer pixel processing filter, and the 2×1 parallelism integer pixel and sub-integer pixel processing filter and the 6×1 parallelism integer pixel and sub-integer pixel processing filter are fully utilized to perform vertical filtering for prediction blocks BK₁ and BK₂ according to a set of 2×6 filtered samples (particularly, 2×6 horizontally filtered samples obtained by preceding horizontal filtering) and a set of 6×6 filtered samples (particularly, 6×6 horizontally filtered samples obtained by preceding horizontal filtering).

The 2×1 parallelism integer pixel and sub-integer pixel processing filter (which is the first part of the vertical filter 115_2) may be repeatedly used for calculating following sets of 2×1 vertically filtered samples, and the 6×1 parallelism integer pixel and sub-integer pixel processing filter (which is the second part of the vertical filter 115_2) may be repeatedly used for calculating following sets of 6×1 vertically filtered samples. For example, during the second clock cycle of the vertical filtering of parallel 2×8 prediction block interpolation and 6×8 prediction block interpolation, a next set of 2×6 horizontally filtered samples may be read from the working buffer and fed into the 2×1 parallelism integer pixel and sub-integer pixel processing filter (which is the first part of the vertical filter 115_2) for calculation of a next set of 2×1 vertically filtered samples, and a next set of 6×6 horizontally filtered samples may be read from the working buffer and fed into the 6×1 parallelism integer pixel and sub-integer pixel processing filter (which is the second part of the vertical filter 115_2) for calculation of a next set of 6×1 vertically filtered samples. After the vertical filtering of 2×8 prediction block interpolation and 6×8 prediction block interpolation is done, two final outputs (which include all horizontally and vertically filtered samples of the 2×8 prediction block BK₁ and the 6×8 prediction block BK₂) are generated.

As shown in FIG. 13, multiple parallelism integer pixel and sub-integer pixel processing filters reconfigured from one L×1 parallelism integer pixel and sub-integer pixel processing filter (e.g., horizontal filter 115_1) are used to perform interpolation filtering upon input samples (e.g., raw integer pixels) in a pixel row direction, and multiple parallelism integer pixel and sub-integer pixel processing filters reconfigured from another L×1 parallelism integer pixel and sub-integer pixel processing filter (e.g., vertical filter 115_2) are used to perform interpolation filtering upon filtered samples (e.g., horizontally filtered integer pixels or horizontally filtered sub-integer pixels) in a pixel column direction to generate final outputs (e.g., horizontally and vertically filtered samples of different prediction blocks). Alternatively, the composed integer pixel and sub-integer pixel processing filter architecture may be applied to an interpolation application that needs to perform the vertical filtering first and then the horizontal filtering.

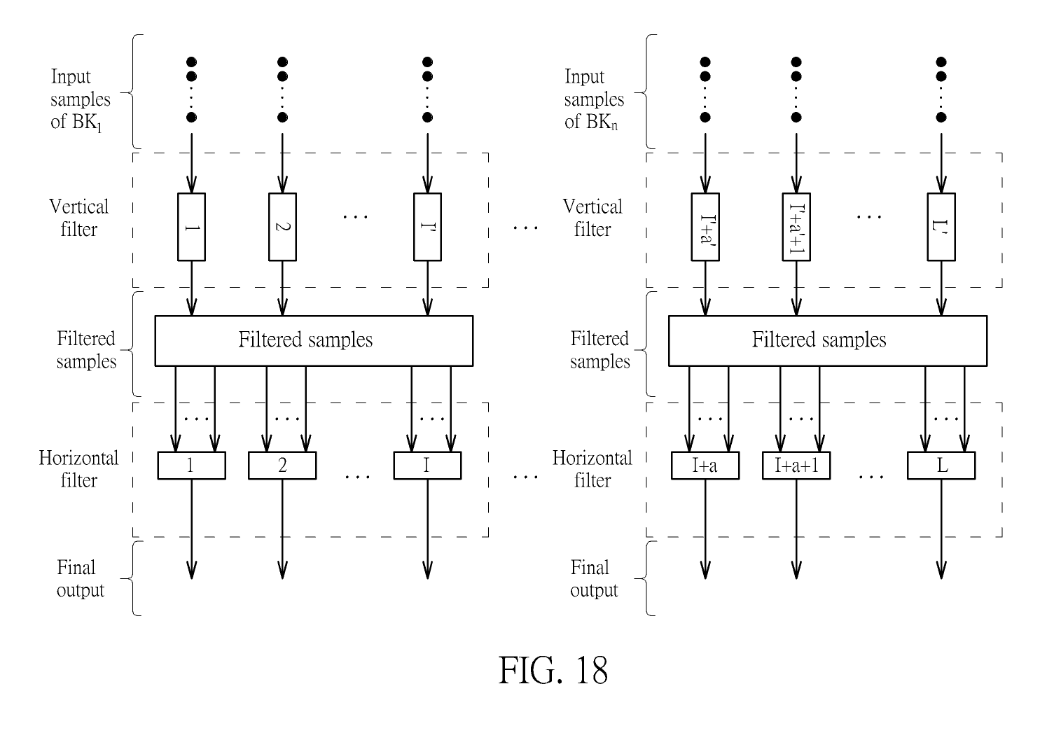

FIG. 18 is a diagram illustrating composed integer pixel and sub-integer pixel processing filter architecture used under a second processing order (e.g., vertical filtering→horizontal filtering) according to an embodiment of the present invention. Since each T-tap filter of a horizontal filter (e.g., horizontal filter 115_1) requires T vertically filtered samples at the same row to generate one horizontally filtered sample, the number of T-tap filters implemented in a vertical filter (e.g., vertical filter 115_2) may be different from the number of T-tap filters implemented in the horizontal filter (e.g., horizontal filter 115_1). In a case where the composed integer pixel and sub-integer pixel processing filter architecture is implemented by the motion compensation circuit 114, the horizontal filter 115_1 may have L×1 T-tap filters that can be fully utilized for parallel horizontal filtering of multiple prediction blocks BK₁-BKₙ with widths W₁-Wₙ (L=W₁+W₂+ . . . +Wₙ), and the vertical filter 115_2 may have [L+(T−1)×n] T-tap filters that can be fully utilized for parallel vertical filtering of multiple prediction blocks BK₁-BKₙ with widths W₁-Wₙ. The difference between the number of T-tap filters needed by a fully-utilized vertical filter and the number of T-tap filters needed by a fully-utilized horizontal filter is increased when the value of n (i.e., the number of prediction blocks to be processed in parallel) is larger, and the difference between the number of T-tap filters needed by a fully-utilized vertical filter and the number of T-tap filters needed by a fully-utilized horizontal filter is decreased when the value of n (i.e., the number of prediction blocks to be processed in parallel) is smaller. In another case where the composed integer pixel and sub-integer pixel processing filter architecture is employed to multiple prediction blocks BK₁-BKₘ with widths W₁-Wₘ (L=W₁+W₂+ . . . +Wₘ & m<n), only a portion of the vertical filter 115_2 (e.g., P×1 parallelism integer pixel and sub-integer pixel processing filter, where P=L+(T−1)×m<L+(T−1)×n) can be allowed to be split into integer pixel and sub-integer pixel processing filters fully utilized for parallel vertical filtering of multiple prediction blocks BK₁-BKₘ. In short, when the composed integer pixel and sub-integer pixel processing filter architecture is employed to perform parallel processing of a first group of prediction blocks (e.g., prediction blocks BK₁-BKₙ with widths W₁-Wₙ), the horizontal filter 115_1 and the vertical filter 115_2 may be fully used; and when the composed integer pixel and sub-integer pixel processing filter architecture is employed to perform parallel processing of a second group of prediction blocks (e.g., prediction blocks BK₁-BKₘ with widths W₁-Wₘ), the horizontal filter 115_1 may be fully utilized, while the vertical filter 115_2 may be partially utilized. However, this is for illustrative purposes only, and is not meant to be a limitation of the present invention.

Although the number of T-tap filters implemented in a vertical filter (e.g., vertical filter 115_2) may be different from the number of T-tap filters implemented in the horizontal filter (e.g., horizontal filter 115_1) when the vertical filter and the horizontal filter operate under the second processing order (e.g., vertical filtering→horizontal filtering), the principle of the composed integer pixel and sub-integer pixel processing filter architecture shown in FIG. 18 is similar to that of the composed integer pixel and sub-integer pixel processing filter architecture shown in FIG. 13.

Suppose that the horizontal filter 115_1 is designed to have L×1 T-tap filters implemented therein, and the vertical filter 115_2 is designed to have L′×1 T-tap filters implemented therein, where L′=L+(T−1)×n. To achieve full utilization of the horizontal filter 115_1 and the vertical filter 115_2 under a condition that multiple prediction blocks BK₁-BKₙ with widths W₁-Wₙ (L=W₁+W₂+ . . . +Wₙ) are to be processed in parallel, the filter configuration circuit 304 of the horizontal filter 115_1 reconfigures the L×1 parallelism integer pixel and sub-integer pixel processing filter 302 into a plurality of parallelism integer pixel and sub-integer pixel processing filters according to widths of the prediction blocks, respectively, and the filter configuration circuit of the vertical filter 115_2 reconfigures the L′×1 parallelism integer pixel and sub-integer pixel processing filter into a plurality of parallelism integer pixel and sub-integer pixel processing filters according to widths of the prediction blocks, respectively. In this example, I=W₁, L−(I+a)+1=Wₙ, I′=W₁+(T−1), and L′−(I′+a′)+1=Wₙ+(T−1). A value of the variable “a” shown in FIG. 18 depends on the number of T-tap filters possessed by all intermediate horizontal filters (not shown) between the first horizontal filter and the last horizontal filter. For example, if there is no intermediate horizontal filter created by the composed integer pixel and sub-integer pixel processing filter architecture, the value of the variable “a” is set by 1. In addition, a value of the variable “a” shown in FIG. 18 depends on the number of T-tap filters possessed by all intermediate vertical filters (not shown) between the first vertical filter and the last vertical filter. For example, if there is no intermediate vertical filter created by the composed integer pixel and sub-integer pixel processing filter architecture, the value of the variable “a” is set by 1. The parallelism integer pixel and sub-integer pixel processing filters composed in the vertical filter 115_2 are used to serve as vertical filters for performing interpolation filtering upon input samples (e.g., raw integer pixels of different prediction blocks) in a pixel column direction, and the parallelism integer pixel and sub-integer pixel processing filters composed in the horizontal filter 115_1 are used to serve as horizontal filters for performing interpolation filtering upon filtered samples (e.g., vertically filtered integer pixels or vertically filtered sub-integer pixels) in a pixel row direction to generate final outputs (e.g., vertically and horizontally filtered samples of different prediction blocks). Since a person skilled in the art can readily understand the principle of the composed integer pixel and sub-integer pixel processing filter architecture shown in FIG. 18 after reading above paragraphs directed to the composed integer pixel and sub-integer pixel processing filter architecture shown in FIG. 13, further description is omitted here for brevity.

In above embodiments, each of the folded integer pixel and sub-integer pixel processing filter architecture and the composed integer pixel and sub-integer pixel processing filter architecture is employed to reconfigure both of horizontal filter 115_1 and vertical filter 115_2. However, this is not meant to be a limitation of the present invention. Any interpolation application using the folded integer pixel and sub-integer pixel processing filter architecture to reconfigure one of horizontal filter 115_1 and vertical filter 115_2 still falls within the scope of the present invention. Similarly, any interpolation application using the composed integer pixel and sub-integer pixel processing filter architecture to reconfigure one of horizontal filter 115_1 and vertical filter 115_2 still falls within the scope of the present invention.

As mentioned above, the proposed reconfigurable interpolation filter 300 shown in FIG. 3 can be used to realize each of horizontal filter 115_1 and vertical filter 115_2 of the motion compensation circuit 114 at the video decoder 100. However, this is not meant to be a limitation of the present invention. Any interpolation application using the proposed reconfigurable interpolation filter 300 falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reconfigurable interpolation filter comprising:
an L×1 parallelism integer pixel and sub-integer pixel processing filter, arranged to calculate L filtered samples at a same pixel line in a parallel fashion, wherein L is a positive integer not smaller than one; and
a filter configuration circuit, arranged to reconfigure the L×1 parallelism integer pixel and sub-integer pixel processing filter into an (L/M)×M parallelism integer pixel and sub-integer pixel processing filter according to a width of a prediction block, wherein the (L/M)×M parallelism integer pixel and sub-integer pixel processing filter is arranged to process the prediction block by calculating L/M filtered samples at each of M pixel lines in a parallel fashion, M is a positive integer not smaller than one, and L/M is a positive integer.

2. The reconfigurable interpolation filter of claim 1, wherein the reconfigurable interpolation filter is a horizontal filter, and each of the M pixel lines is one pixel row.

3. The reconfigurable interpolation filter of claim 2, wherein the horizontal filter performs interpolation filtering upon input samples in a pixel row direction to generate horizontally filtered samples, and the horizontally filtered samples are used by interpolation filtering performed in a pixel column direction.

4. The reconfigurable interpolation filter of claim 2, wherein the horizontal filter performs interpolation filtering upon vertically filtered samples in a pixel row direction.

5. The reconfigurable interpolation filter of claim 1, wherein the reconfigurable interpolation filter is a vertical filter, and each of the M pixel lines is one pixel row.

6. The reconfigurable interpolation filter of claim 5, wherein the vertical filter performs interpolation filtering upon input samples in a pixel column direction to generate vertically filtered samples, and the vertically filtered samples are used by interpolation filtering performed in a pixel row direction.

7. The reconfigurable interpolation filter of claim 5, wherein the vertical filter performs interpolation filtering upon horizontally filtered samples in a pixel column direction.

8. The reconfigurable interpolation filter of claim 1, wherein the width of the prediction block is equal to L.

9. The reconfigurable interpolation filter of claim 1, wherein the width of the prediction block is different from L.

10. The reconfigurable interpolation filter of claim 9, wherein the width of the prediction block is smaller than L.

11. A reconfigurable interpolation filter comprising:
an L×1 parallelism integer pixel and sub-integer pixel processing filter, arranged to calculate L filtered samples at a same pixel line in a parallel fashion, wherein L is a positive integer not smaller than one; and
a filter configuration circuit, arranged to reconfigure the L×1 parallelism integer pixel and sub-integer pixel processing filter into a plurality of parallelism integer pixel and sub-integer pixel processing filters according to widths of a plurality of prediction blocks, respectively, wherein the parallelism integer pixel and sub-integer pixel processing filters are arranged to process the prediction blocks by calculating filtered samples in a parallel fashion, and each of the parallelism integer pixel and sub-integer pixel processing filters is arranged to calculate filtered samples at a same pixel line.

12. The reconfigurable interpolation filter of claim 11, wherein the reconfigurable interpolation filter is a horizontal filter, and said same pixel line is one pixel row.

13. The reconfigurable interpolation filter of claim 12, wherein the horizontal filter performs interpolation filtering upon input samples in a pixel row direction to generate horizontally filtered samples, and the horizontally filtered samples are used by interpolation filtering performed in a pixel column direction.

14. The reconfigurable interpolation filter of claim 12, wherein the horizontal filter performs interpolation filtering upon vertically filtered samples in a pixel row direction.

15. The reconfigurable interpolation filter of claim 11, wherein the reconfigurable interpolation filter is a vertical filter, and said same pixel line is one pixel row.

16. The reconfigurable interpolation filter of claim 15, wherein the vertical filter performs interpolation filtering upon input samples in a pixel column direction to generate vertically filtered samples, and the vertically filtered samples are used by interpolation filtering performed in a pixel row direction.

17. The reconfigurable interpolation filter of claim 15, wherein the vertical filter performs interpolation filtering upon horizontally filtered samples in a pixel column direction.

18. The reconfigurable interpolation filter of claim 11, wherein a sum of the widths of the prediction blocks is equal to or smaller than L.

19. The reconfigurable interpolation filter of claim 18, wherein the prediction blocks comprise prediction blocks with a same width.

20. The reconfigurable interpolation filter of claim 18, wherein, wherein the prediction blocks comprise prediction blocks with different widths.

21. An interpolation filtering method comprising:
utilizing an L×1 parallelism integer pixel and sub-integer pixel processing filter for calculating L filtered samples at a same pixel line in a parallel fashion, wherein L is a positive integer not smaller than one;
reconfiguring the L×1 parallelism integer pixel and sub-integer pixel processing filter into an (L/M)×M parallelism integer pixel and sub-integer pixel processing filter according to a width of a prediction block; and
utilizing the (L/M)×M parallelism integer pixel and sub-integer pixel processing filter to process the prediction block by calculating L/M filtered samples at each of M pixel lines in a parallel fashion, M is a positive integer not smaller than one, and L/M is a positive integer.

22. An interpolation filtering method comprising:
utilizing an L×1 parallelism integer pixel and sub-integer pixel processing filter for calculating L filtered samples at a same pixel line in a parallel fashion, wherein L is a positive integer not smaller than one;
reconfiguring the L×1 parallelism integer pixel and sub-integer pixel processing filter into a plurality of parallelism integer pixel and sub-integer pixel processing filters according to widths of a plurality of prediction blocks, respectively; and
utilizing the parallelism integer pixel and sub-integer pixel processing filters to process the prediction blocks by calculating filtered samples associated with the prediction blocks in a parallel fashion, wherein each of the parallelism integer pixel and sub-integer pixel processing filters calculates filtered samples at a same pixel line.
